(19) United States
(12) Patent Application Publication
(10) Pub. No.: US 2009/0203419 A1
(43) Pub. Date: Aug. 13, 2009

(54) Gaming system providing return to players and method for controlling gaming machine

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/216,784

(22) Filed: Jul. 10, 2008

Related U.S. Application Data
(60) Provisional application No. 61/027,631, filed on Feb. 11, 2008.

(51) Int. Cl. A63F 9/24; A63F 13/00

(52) U.S. Cl. 463/20

(57) ABSTRACT

A gaming system of the present invention provides in each gaming machine a normal award, based on symbols rearranged to a first display portion or a combination thereof; meanwhile, when a first specific symbol is rearranged to any of display blocks in the first display portion, the gaming machine additionally displays the first specific symbol to the corresponding display block in the second display portion, and the gaming machine provides a special award when a plurality of the first specific symbols are displayed to the second display portion in a specific arrangement. Further, when the first specific symbol is rearranged to any of display blocks in a first display portion of another gaming machine capable of communicating through a communication line, the gaming machine additionally displays this symbol to the corresponding display block in the second display, as a second specific symbol.

### CROSS-REFERENCE TO RELATED APPLICATIONS

This application claims benefit of priority based on U.S. Provisional Patent Application No. 61/027,631 filed on Feb. 11, 2008. The contents of this application are incorporated herein by reference in their entirety.

### BACKGROUND OF THE INVENTION

1. Field of the Invention

The present invention relates to a gaming system providing a return to players and a method for controlling a gaming machine.

2. Discussion of the Background

Conventionally, in a gaming machine such as a slot machine, a payout has been conducted on condition that a predetermined combination is established and won. However, there has been a problem that the player suffers a great loss since the player cannot receive a payout when a predetermined internal winning combination is not easily established or when, even if the internal winning combination has been established, the internal winning combination is not easily won.

Therefore, for example, a gaming machine such as a one disclosed in U.S. Pat. No. 5,910,048 has been developed that provides a return to the player when the amount of losses of the player has reached a predetermined level. According to such a gaming machine, the player can receive a predetermined return when, for example, no winning has been occurred during a predetermined number of games.

However, in the above-mentioned gaming machine, no relief is provided for the player when losses have continued to increase after a return has been once provided to the player for the losses of the player reaching the predetermined level. For example, in a gaming machine in which a return is provided when no winning has occurred during a predetermined number of games, in a case where the player keeps missing a winning after a receipt of a return for not winning during the predetermined number of games, the player cannot receive a return (unless the number of games with no winnings reaches the above-mentioned predetermined number of games). As just described, there has been a problem in the conventional gaming machines that enough relief is not provided for a player who has suffered losses of a previously determined level or more.

The present invention has been completed in view of the above-described problem, and an object thereof is to provide a gaming system capable of providing relief for a player having kept suffering losses in games and a method for controlling a gaming machine.

The contents of U.S. Pat. No. 5,910,048 are incorporated herein by reference in their entirety.

### SUMMARY OF THE INVENTION

A first aspect of the present invention provides a gaming system having the following configuration.

Namely, the above-mentioned gaming system comprises: a plurality of gaming machines capable of communicating with one another through a communication line, each of the gaming machines including a display to which an image can be displayed and a controller. The controller is programmed to conduct the processing of (a) displaying, to the display, a first display portion having display blocks arranged in a matrix with equal numbers of rows and columns and a second display portion having display blocks arranged in a matrix with the same dimensions as the dimensions of the matrix in the first display portion, (b) rearranging a symbol to each of the display blocks in the first display portion, (c) providing a normal award, based on the symbols rearranged to the first display portion or a combination of the symbols, (d) additionally displaying, when a first specific symbol is rearranged to any of the display blocks in the first display portion, this first specific symbol to the corresponding display block in the second display portion, (e) additionally displaying the first specific symbol, which has been rearranged to any of display blocks in a first display portion of another gaming machine capable of communicating through the communication line, to the corresponding display block in the second display portion, as a second specific symbol, and (f) providing a special award, when a plurality of the first specific symbols are displayed to the second display portion in a specific arrangement as a result of repeatedly conducting the processing (d) and the processing (e).

According to the above-mentioned gaming system, in each gaming machine, the normal award is provided based on the symbols rearranged to the first display portion or a combination thereof. Meanwhile, when the first specific symbol has been rearranged to any of the display blocks in the first display portion, the first specific symbol is additionally displayed to the corresponding display block in the second display portion; and the special award is provided when the first specific symbols are displayed to the second display portion in the specific arrangement (e.g., an arrangement forming a bingo combination).

Further, when a first specific symbol is rearranged to any of display blocks in a first display portion in another gaming machine capable of communicating through a communication line, the symbol is additionally displayed, as a second specific symbol, to the corresponding display block in the second display portion.

More specifically, in each of the gaming machines configuring the gaming system, there is provided the special award based on the arrangement of the first specific symbols displayed to the second display portion, separately from the normal award based on the symbols rearranged in the first display portion or a combination thereof. Therefore, there is a possibility that even a player having difficulty in acquiring the normal award in games in the first display portion wins the special award. Further, this special award is provided every time the first specific symbols are displayed to the second display portion in the specific arrangement regardless of the number of continuous losses in games in the first display portion. Accordingly, it is possible to continuously provide a return to the player who cannot receive the normal award and suffers increasing losses.

Also, as described above, in the second display portion, in addition to a first specific symbol rearranged in the first display portion of the gaming machine being displayed, a first specific symbol rearranged in a first display portion of another gaming machine is displayed as a second specific symbol. Accordingly, there can be added a new game property of displaying the first specific symbols in the specific arrangement in order to receive a return under an environment where the first specific symbols and the second specific symbols are displayed.

As described above, according to the gaming system, a new game property can be added, concurrently with providing relief for the player who cannot acquire the normal award; thus, it is possible to ease psychological burden on the player of continuously losing games in the first display portion.

Further, the above-mentioned gaming system desirably has the following configuration.

Namely, the controller is further programmed to conduct the processing of (g) resetting the display of the first specific symbol and the second specific symbol in the second display portion, when an award previously determined based on the symbols rearranged to the first display portion or a combination of the symbols has been provided in the processing (c).

According to the above-mentioned gaming system, the display of the first specific symbol in the second display portion is reset when an award based on the symbols rearranged to the first display portion or a combination thereof is a previously determined award (e.g., a payout of a predetermined amount of game media, and generation of a bonus game).

More specifically, a game for providing relief in the second display portion is reset when a certain amount of profit has been provided to the player in games in the first display portion. Thus, it is possible to prevent a superfluous provision of a profit to the player who has acquired the profit in the games in the first display portion, and to more accurately provide a return to the player who has not been able to acquire a profit.

Further, the above-mentioned gaming system desirably has the following configuration.

Namely, each of the gaming machines further comprises a BET input device with which a BET can be input; and the processing (a) includes displaying to the display, a first display portion having display blocks arranged in a matrix with equal numbers of rows and columns, and displaying to the display, a second display portion having display blocks arranged in a matrix with the same dimensions as the dimensions of the matrix in the first display portion, when a predetermined amount of BET has been input through the BET input device.

According to the above-mentioned gaming system, a game is executed for providing relief in the second display portion when a predetermined amount of BET has been placed.

Accordingly, when the player desires for relief in a case of continuously losing games, it is possible to accurately provide a return to the player by making the player place a predetermined amount of BET.

Furthermore, the above-mentioned gaming system desirably has the following configuration.

Namely, the controller is further programmed to conduct the processing of (h) resetting, when the first specific symbol is rearranged to any of the display blocks in the first display portion and the second specific symbol has been displayed to the corresponding display block in the second display portion, the display of the second specific symbol in the corresponding display block in the second display portion; and (i) resetting, when the first specific symbol has been displayed to any of the display blocks in the second display portion and the first specific symbol is rearranged to the corresponding display block in a first display portion of any of the other gaming machines capable of communicating through the communication line, the display of the first specific symbol in the corresponding display block in the second display portion.

According to the above-mentioned gaming system, when the first specific symbol is rearranged to the first display portion at the time that the second specific symbol has been already displayed to the corresponding display block in the second display portion, the display of this second specific symbol is reset; meanwhile, in the state in which the first specific symbol has been already displayed in any of the display blocks in the second display portion, when the first specific symbol is rearranged to the corresponding display block in the first display portion of any of the other gaming machines, the display of the first specific symbol that has been already displayed in the second display portion is reset.

More specifically, when the first specific symbol is rearranged to the first display portion of a single gaming machine, the second specific symbol, i.e., the first specific symbol in other gaming machines is cleared; meanwhile, when the first specific symbol is rearranged in the first display portion of another gaming machine, the first specific symbol already displayed in this single gaming machine is cleared. Therefore, in a game in the second display portion, since the player competes against a player on another gaming machine, it becomes possible to increase pleasure of the player at the time of receiving a return, and to make the game for receiving a return more entertaining.

Further, the above-mentioned gaming system desirably has the following configuration.

Namely, the processing (f) includes providing a special award, when the first specific symbol has been displayed to all the display blocks in a single row, column, and/or diagonal of the second display portion as a result of repeatedly conducting the processing (d) and the processing (e).

According to the above-mentioned gaming system, the special award is provided when the arrangement of the first specific symbols displayed in the second display portion is in a bingo state.

Accordingly, a new game property of establishing a bingo combination with the first specific symbols under an environment where the first specific symbol and the second specific symbol are displayed can be added, concurrently with providing relief for a player who cannot acquire the normal award. Thus, it is possible to ease psychological burden on the player of continuously losing games in the first display portion.

The second aspect of the present invention provides a gaming system having the following configuration.

Namely, the gaming system comprises: a plurality of gaming machines capable of communicating with one another through a communication line, each of the gaming machines including a display to which an image can be displayed, a selection input device with which a selection operation of whether or not to receive an award can be input, and a controller. The controller is programmed to conduct the processing of (a) displaying, to the display, a first display portion having display blocks arranged in a matrix with equal numbers of rows and columns and a second display portion having display blocks arranged in a matrix with the same dimensions as the dimensions of the matrix in the first display portion, (b) rearranging a symbol to each of the display blocks in the first display portion, (c) providing a normal award, based on the symbols rearranged to the first display portion or a combination of the symbols, (d) additionally displaying, when a first specific symbol is rearranged to any of the display blocks in the first display portion, this first specific symbol to the corresponding display block in the second display portion, (e) additionally displaying the first specific symbol, which has been rearranged to any of display blocks in a first display portion of another gaming machine capable of communicating through the communication line, to the corresponding display block in the second display portion, as a second specific symbol, (f) providing a special award, when a plurality of the first specific symbols are displayed to the second display portion in a first specific arrangement as a result of repeatedly conducting the processing (d) and the processing (e) and an input of receiving the award is entered through the selection input device, and (g) providing an award larger than the special award, when a plurality of the first specific symbols are displayed to the second display portion in a second specific arrangement after an input of not receiving the award has been entered, through the selection input device, for the first specific arrangement of a plurality of the first specific symbols displayed in the second display portion as a result of repeatedly conducting the processing (d) and the processing (e).

According to the above-mentioned gaming system, in each of the gaming machines, the normal award is provided based on the symbols rearranged to the first display portion or a combination thereof. Further, when the first specific symbol has been rearranged to any of the display blocks in the first display portion, the first specific symbol is additionally displayed to the corresponding display block in the second display portion; and the special award is provided when the first specific symbols are displayed to the second display portion in the first specific arrangement (e.g., an arrangement forming a bingo combination in a column) and an input of receiving the award has been entered. Moreover, the award larger than the special award is provided when an input of not receiving the award has been entered for the first specific arrangement of the first specific symbols displayed in the second display portion and thereafter, the first specific symbols are displayed in the second display portion in the second specific arrangement (e.g., an arrangement forming a bingo combination established along a single column and a single row).

Further, when a first specific symbol is rearranged to any of display blocks in a first display portion in another gaming machine capable of communicating through a communication line, the symbol is additionally displayed, as a second specific symbol, to the corresponding display block in the second display portion.

More specifically, in each of the gaming machines configuring the gaming system, there is provided the special award based on the arrangement of the first specific symbols displayed to the second display portion, separately from the normal award based on the symbols rearranged to the first display portion or a combination thereof. Therefore, there is a possibility that even a player having difficulty in acquiring the normal award in games in the first display portion wins the special award. Further, this special award is provided every time the first specific symbols are displayed to the second display portion in the specific arrangement (the first specific arrangement, second specific arrangement) regardless of the number of continuous losses in games in the first display portion. Accordingly, it is possible to continuously provide a return to the player who cannot receive the normal award and suffers increasing losses.

Also, as described above, in the second display portion, in addition to a first specific symbol rearranged in the first display portion of the gaming machine being displayed, a first specific symbol rearranged in a first display portion of another gaming machine is displayed as a second specific symbol. Accordingly, there can be added a new game property of displaying the first specific symbols in the specific arrangement under an environment where the first specific symbols and the second specific symbols are displayed, in order to receive a return.

As described above, a new game property can be added, concurrently with providing relief for the player who cannot acquire the normal award; thus, it is possible to ease psychological burden on the player of continuously losing games in the first display portion.

Also, when the first specific symbols have been displayed in the first specific arrangement in the second display portion, the player can select whether or not to receive the award based on the arrangement. The player can acquire the special award when the player has selected to receive the award. Meanwhile, the player can acquire the larger award than the special award, when the player has chosen not to receive the award and thereafter the first specific symbols have been displayed in the second specific arrangement. This means that the player can receive the special award when the first specific symbols are arranged in the first specific arrangement, or the player can continue on games in order to receive a larger award until the first specific symbols are displayed in the second specific arrangement, without receiving the special award. Therefore, the player can select the level of relief to receive, whereby it becomes possible to meet the needs of more players who desire for relief.

Further, the above-mentioned gaming system desirably has the following configuration.

Namely, the controller is further programmed to conduct the processing of (h) resetting the display of the first specific symbol in the second display portion, when an award previously determined based on the symbols rearranged to the first display portion or a combination of the symbols has been provided in the processing (c).

According to the above-mentioned gaming system, the display of the first specific symbol in the second display portion is reset when an award based on the symbols rearranged to the first display portion or a combination thereof is a previously determined award (e.g., a payout of a predetermined amount of game media, and generation of a bonus game).

More specifically, a game for providing relief in the second display portion is reset when a certain amount of profit has been provided to the player in games in the first display portion. Thus, it is possible to prevent a superfluous provision of a profit to the player who has acquired the profit in the games in the first display portion, and to more accurately provide a return to the player who has not been able to acquire a profit.

Further, the above-mentioned gaming system desirably has the following configuration.

Namely, each of the gaming machines further comprises a BET input device with which a BET can be input; and the processing (a) includes displaying to the display, a first display portion having display blocks arranged in a matrix with equal numbers of rows and columns, and displaying to the display, a second display portion having display blocks arranged in a matrix with the same dimensions as the dimensions of the matrix in the first display portion, when a predetermined amount of BET has been input through the BET input device.

According to the above-mentioned gaming system, a game is executed for providing relief in the second display portion when a predetermined amount of BET has been placed.

Accordingly, when the player desires for relief in a case of continuously losing games, it is possible to accurately provide a return to the player by making the player place a predetermined amount of BET.

Further, the above-mentioned gaming system has the following configuration.

Namely, the controller is further programmed to conduct the processing of (i) resetting, when the first specific symbol is rearranged to any of the display blocks in the first display portion and the second specific symbol has been displayed to the corresponding display block in the second display portion, the display of the second specific symbol in the corresponding display block in the second display portion; and (j) resetting, when the first specific symbol has been displayed to any of the display blocks in the second display portion and the first specific symbol is rearranged to the corresponding display block in a first display portion of any of the other gaming machines capable of communicating through the communication line, the display of the first specific symbol in the corresponding display block in the second display portion.

According to the above-mentioned gaming system, when the first specific symbol is rearranged to the first display portion at the time that the second specific symbol has been already displayed to the corresponding display block in the second display portion, the display of this second specific symbol is reset; meanwhile, in the state in which the first specific symbol has been already displayed in any of the display blocks in the second display portion, when the first specific symbol is rearranged to the corresponding display block in the first display portion of any of the other gaming machines, the display of the first specific symbol that has been already displayed in the second display portion is reset.

More specifically, when the first specific symbol is rearranged to the first display portion of a single gaming machine, the second specific symbol, i.e., the first specific symbol in other gaming machines is cleared; meanwhile, when the first specific symbol is rearranged in the first display portion of another gaming machine, the first specific symbol already displayed in this single gaming machine is cleared. Therefore, in a game in the second display portion, since the player competes against a player on another gaming machine, it becomes possible to increase pleasure of the player at the time of receiving a return, and to make the game for receiving a return more entertaining.

Further, the above-mentioned gaming system desirably comprises the following configuration.

Namely, said processing (f) includes providing a special award, when the first specific symbol has been displayed to all the display blocks in a single row, column, and/or diagonal of the second display portion as a result of repeatedly conducting the processing (d) and the processing (e) and an input of receiving the award has been entered through the selection input device; and the processing (g) includes providing an award larger than the special award, when the first specific symbol is displayed to all the display blocks in a single row, column, and/or diagonal of the second display portion after an input of not receiving the award has been entered, through the selection input device, for the first specific symbol being displayed in all the display blocks in another single row, column, and/or diagonal of the second display portion, as a result of repeatedly conducting the processing (d) and the processing (e).

According to the above-mentioned gaming system, the special award is provided when the first specific symbols displayed in the second display portion are in a bingo state and an input of receiving the award is entered. Moreover, an award larger than the special award is provided when an input of not receiving the award for the first specific symbols being in a bingo state is entered and thereafter, another bingo combination of first specific symbols is established.

Accordingly, a new game property of establishing a bingo combination with the first specific symbols under an environment where the first specific symbols and the second specific symbols are displayed can be added, concurrently with providing relief for a player who cannot acquire the normal award. Thus, it is possible to ease psychological burden on the player of continuously losing games in the first display portion.

Further, the player can receive the special award when the first specific symbols are displayed in a bingo state, or the player can continue on games without receiving the special award in order to receive a larger award until the first specific symbols are displayed in a bingo state along more lines. Therefore, the player can select the level of relief to receive, whereby it becomes possible to meet the needs of more players who desire for relief.

The third aspect of the present invention provides a method for controlling a gaming machine, the method having the following configuration.

Namely, the above-mentioned method for controlling a gaming machine is a method for controlling a gaming machine used in a gaming system comprising a plurality of gaming machines capable of communicating with one another through a communication line, each of the gaming machines including a display to which an image can be displayed and a controller, the method comprising the steps of: (a) displaying, to the display, a first display portion having display blocks arranged in a matrix with equal numbers of rows and columns and a second display portion having display blocks arranged in a matrix with the same dimensions as the dimensions of the matrix in the first display portion; (b) rearranging a symbol to each of the display blocks in the first display portion; (c) providing a normal award, based on the symbols rearranged to the first display portion or a combination of the symbols; (d) additionally displaying, when a first specific symbol is rearranged to any of the display blocks in the first display portion, this first specific symbol to the corresponding display block in the second display portion; (e) additionally displaying the first specific symbol, which has been rearranged to any of display blocks in a first display portion of another gaming machine capable of communicating through the communication line, to the corresponding display block in the second display portion, as a second specific symbol; and (f) providing a special award, when a plurality of the first specific symbols are displayed to the second display portion in a specific arrangement as a result of repeatedly conducting the step (d) and the step (e), each of the steps conducted by the controller.

According to the above-mentioned method for controlling a gaming machine, in each gaming machine, the normal award is provided based on the symbols rearranged to the first display portion or a combination thereof. Meanwhile, when the first specific symbol has been rearranged to any of the display blocks in the first display portion, the first specific symbol is additionally displayed to the corresponding display block in the second display portion; and the special award is provided when the first specific symbols are displayed to the second display portion in the specific arrangement (e.g., an arrangement forming a bingo combination).

Further, when a first specific symbol is rearranged to any of display blocks in a first display portion in another gaming machine capable of communicating through a communication line, the symbol is additionally displayed, as a second specific symbol, to the corresponding display block in the second display portion.

More specifically, in each of the gaming machines configuring the gaming system, there is provided the special award based on the arrangement of the first specific symbols displayed to the second display portion, separately from the normal award based on the symbols rearranged in the first display portion or a combination thereof. Therefore, there is a possibility that even a player having difficulty in acquiring the normal award in games in the first display portion wins the special award. Further, this special award is provided every time the first specific symbols are displayed to the second display portion in the specific arrangement regardless of the number of continuous losses in games in the first display portion. Accordingly, it is possible to continuously provide a return to the player who cannot receive the normal award and suffers increasing losses.

Also, as described above, in the second display portion, in addition to a first specific symbol rearranged in the first display portion of the gaming machine being displayed, a first specific symbol rearranged in a first display portion of another gaming machine is displayed as a second specific symbol. Accordingly, there can be added a new game property of displaying the first specific symbols in the specific arrangement in order to receive a return under an environment where the first specific symbols and the second specific symbols are displayed.

As described above, according to the method for controlling a gaming machine, a new game property can be added, concurrently with providing relief for the player who cannot acquire the normal award; thus, it is possible to ease psychological burden on the player of continuously losing games in the first display portion.

Further, above-mentioned method for controlling a gaming machine desirably has the following configuration.

Namely, the method further comprises the step of (g) resetting the display of the first specific symbol in the second display portion, when an award previously determined based on the symbols rearranged to the first display portion or a combination of the symbols has been provided in the step (c), the step conducted by the controller.

According to the above-mentioned method for controlling a gaming machine, the display of the first specific symbol in the second display portion is reset when an award based on the symbols rearranged to the first display portion or a combination thereof is a previously determined award (e.g., a payout of a predetermined amount of game media, and generation of a bonus game).

More specifically, a game for providing relief in the second display portion is reset when a certain amount of profit has been provided to the player in games in the first display portion. Thus, it is possible to prevent a superfluous provision of a profit to the player who has received the profit in the games in the first display portion, and to more accurately provide a return to the player who has not been able to acquire a profit.

Moreover, the above-mentioned method for controlling a gaming machine desirably has the following configuration.

Namely, the step (a) includes the controller displaying to the display, a first display portion having display blocks arranged in a matrix with equal numbers of rows and columns, and displaying to the display, a second display portion having display blocks arranged in a matrix with the same dimensions as the dimensions of the matrix in the first display portion, when a predetermined amount of BET has been input through a BET input device with which a BET can be input.

According to the above-mentioned method for controlling a gaming machine, a game is executed for providing relief in the second display portion when a predetermined amount of BET has been placed.

Accordingly, when the player desires for relief in a case of continuously losing games, it is possible to accurately provide a return to the player by making the player place a predetermined amount of BET.

Furthermore, the above-mentioned method for controlling a gaming machine desirably has the following configuration.

Namely, the method further comprises the steps of: (h) resetting, when the first specific symbol is rearranged to any of the display blocks in the first display portion and the second specific symbol has been displayed to the corresponding display block in the second display portion, the display of the second specific symbol in the corresponding display block in the second display portion; and (i) resetting, when the first specific symbol has been displayed to any of the display blocks in the second display portion and the first specific symbol is rearranged to the corresponding display block in a first display portion of any of the other gaming machines capable of communicating through the communication line, the display of the first specific symbol in the corresponding display block in the second display portion, each of the steps conducted by the controller.

When the first specific symbol is rearranged to the first display portion at the time that the second specific symbol has been already displayed to the corresponding display block in the second display portion, the display of this second specific symbol is reset; meanwhile, in the state in which the first specific symbol has been already displayed in any of the display blocks in the second display portion, when the first specific symbol is rearranged to the corresponding display block in the first display portion of any of the other gaming machines, the display of the first specific symbol that has been already displayed in the second display portion is reset.

More specifically, when the first specific symbol is rearranged to the first display portion of a single gaming machine, the second specific symbol, i.e., the first specific symbol in other gaming machines is cleared; meanwhile, when the first specific symbol is rearranged in the first display portion of another gaming machine, the first specific symbol already displayed in this single gaming machine is cleared. Therefore, in a game in the second display portion, since the player competes against a player on another gaming machine, it becomes possible to increase pleasure of the player at the time of receiving a return, and to make the game for receiving a return more entertaining.

Further, the above-mentioned method for controlling a gaming machine desirably has the following configuration.

Namely, the step (f) includes the controller providing a special award, when the first specific symbol has been displayed to all the display blocks in a single row, column, and/or diagonal of the second display portion as a result of repeatedly conducting the step (d) and the step (e).

According to the above-mentioned gaming system, the special award is provided when the arrangement of the first specific symbols displayed in the second display portion is in a bingo state.

Accordingly, a new game property of establishing a bingo combination with the first specific symbols under an environment where the first specific symbol and the second specific symbol are displayed can be added, concurrently with providing relief for a player who cannot acquire the normal award. Thus, it is possible to ease psychological burden on the player of continuously losing games in the first display portion.

### BRIEF DESCRIPTIONS OF THE DRAWINGS

FIG. 1 is a flowchart illustrating a subroutine of game execution processing.

FIG. 2 is a diagrammatic view illustrating an entire configuration of a gaming system according to the present embodiment.

FIG. 3 is a perspective view illustrating an external view of a slot machine according to the present embodiment.

FIG. 4 is a schematic view illustrating arrays of symbols to be displayed to the respective display blocks.

FIG. 5 is an exemplary view illustrating an image displayed to a lower image display panel.

FIG. 6 is another exemplary view illustrating an image displayed to a lower image display panel.

FIG. 7 is another exemplary view illustrating an image displayed to a lower image display panel.

FIG. 8 is another exemplary view illustrating an image displayed to a lower image display panel.

FIG. 9 is another exemplary view illustrating an image displayed to a lower image display panel.

FIG. 10 is another exemplary view illustrating an image displayed to a lower image display panel.

FIG. 11 is another exemplary view illustrating an image displayed to a lower image display panel.

FIG. 12 is another exemplary view illustrating an image displayed to a lower image display panel.

FIG. 13 is a block diagram illustrating an internal configuration of the slot machine illustrated in FIG. 3.

FIG. 14 is a block diagram illustrating an internal configuration of a server according to the present embodiment.

FIG. 15 is a flowchart illustrating a subroutine of symbol determination processing.

FIG. 16 is a view illustrating relations among a plurality of types of prizes, the probability for establishment of each prize and the number of payouts.

FIG. 17 is a flowchart illustrating a subroutine of first processing of displaying a symbol.

FIG. 18 is a flowchart illustrating a subroutine of return-providing processing.

FIG. 19 is a flowchart illustrating a subroutine of bonus game processing.

FIG. 20 is a flowchart illustrating a subroutine of second processing of displaying a symbol.

FIG. 21 is a flowchart illustrating a subroutine of server side processing executed in a server according to the present embodiment.

### DESCRIPTION OF THE EMBODIMENTS

Descriptions of the embodiments of the present invention will be given based on the drawings.

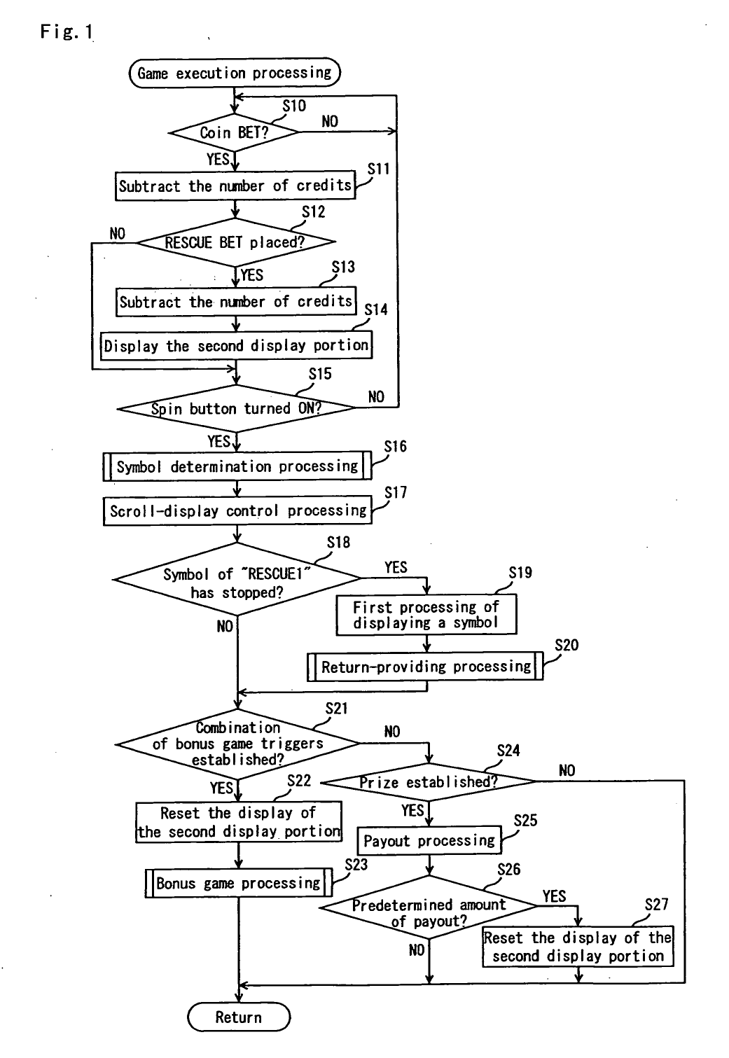

FIG. 1 is a flowchart illustrating a subroutine of game execution processing.

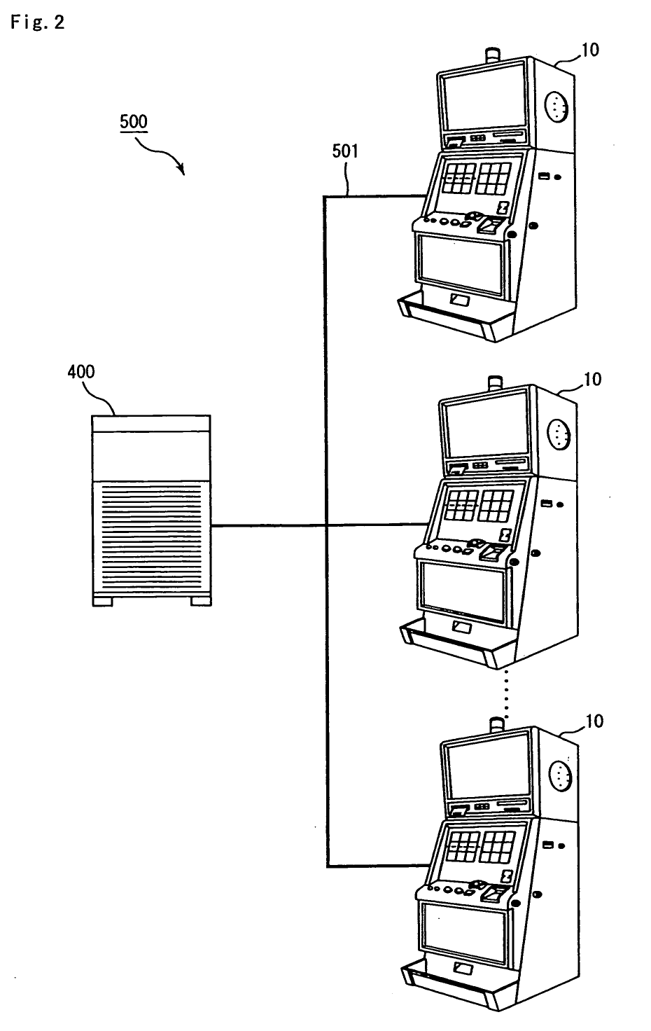

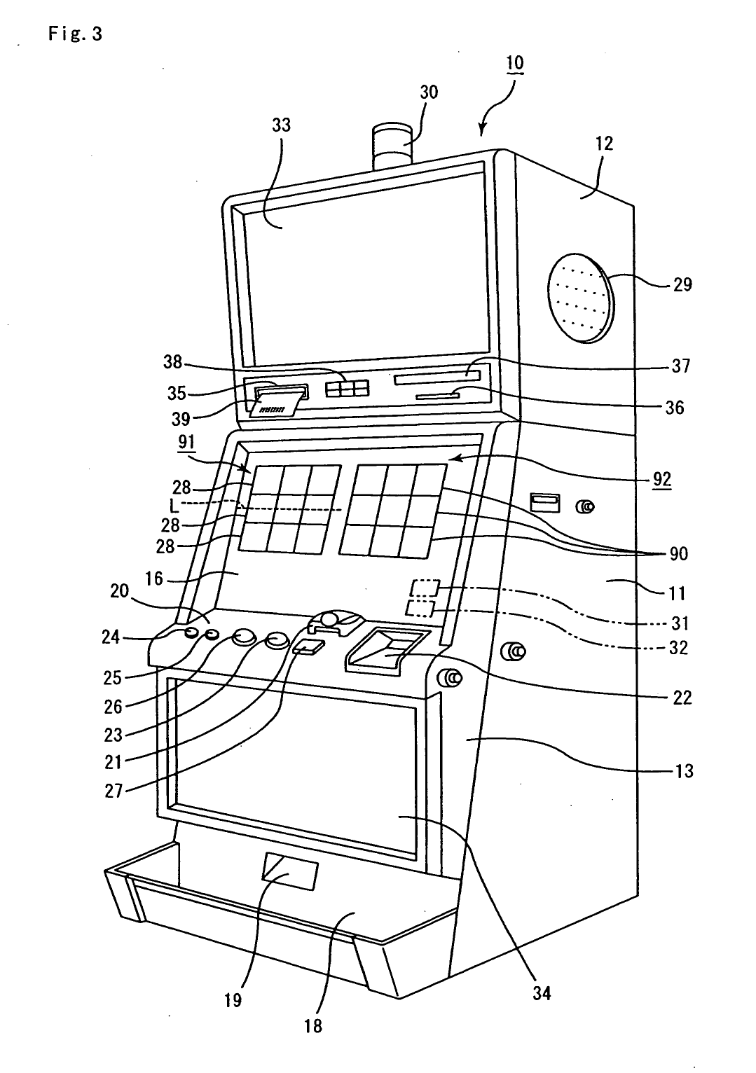

The game execution processing is executed in a slot machine 10 (see FIG. 3) configuring a gaming system 500 (see FIG. 2) in the present embodiment.

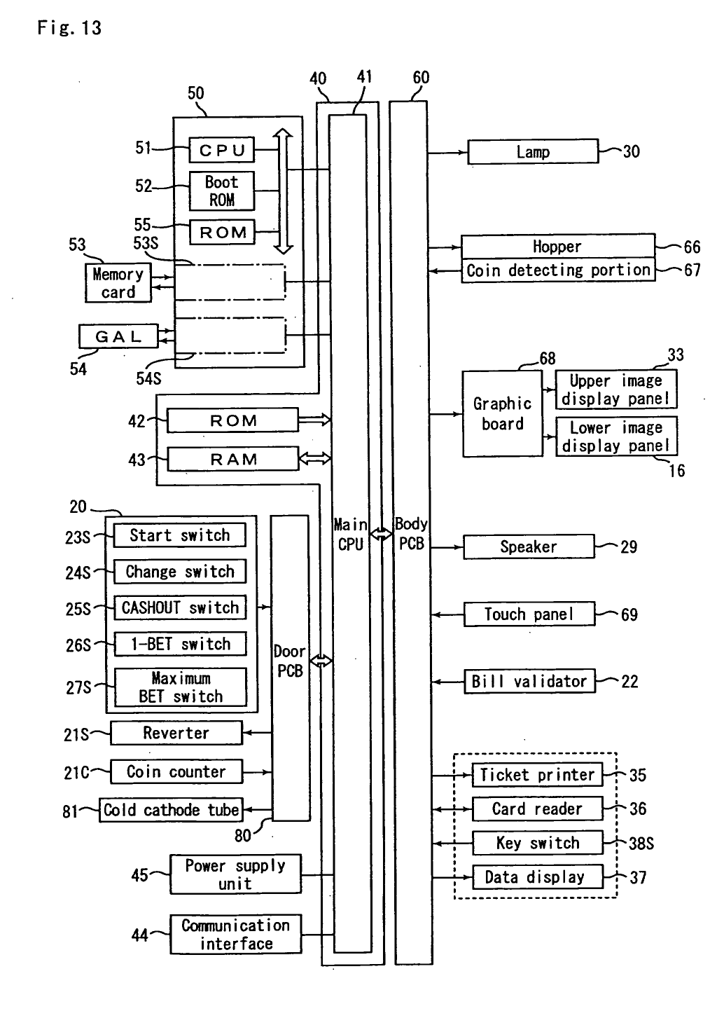

In the game execution processing, first, a main CPU 41 (see FIG. 13) determines whether or not a coin has been BET (step S10). In the processing, the main CPU 41 determines whether or not to have received an input signal that is output from a 1-BET switch 26S (see FIG. 13) when a 1-BET button 26 (see FIG. 3) is operated or an input signal that is output from a maximum BET switch 27 (see FIG. 13) when a maximum BET button 27 (see FIG. 3) is operated. When the main CPU 41 determines that a coin has not been BET, the main CPU 41 returns the processing to step S10.

On the other hand, when the main CPU 41 determines in step S10 that a coin has been BET, the main CPU 41 conducts processing of making a subtraction from the number of credits stored in a RAM 43 (see FIG. 13) according to the number of BET coins (step S11). Here, the main CPU 41 returns the processing to step S10 without conducting the processing of making a subtraction from the number of credits stored in the RAM 43, when the number of BET coins is larger than the number of credits stored in the RAM 43. Further, the main CPU 41 advances the processing to step S12 without conducting the processing of making a subtraction from the number of credits stored in the RAM 43 when the number of BET coins exceeds the upper limit value (50 coins in the present embodiment) that can be BET in one game.

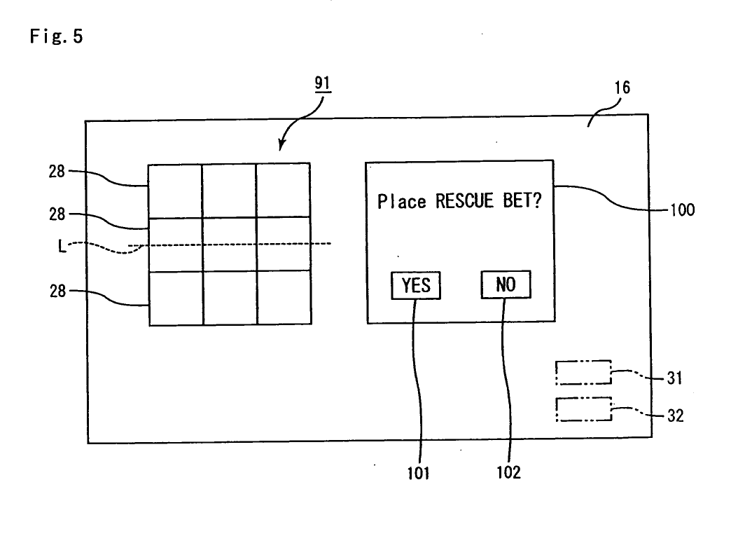

Next, in step S12, the main CPU 41 determines whether or not a “RESCUE BET” has been placed. More specifically, the main CPU 41 determines whether or not an input (see FIG. 5) of placing the “RESCUE BET” has been entered through a touch panel 69 (see FIG. 13). The touch panel 69 corresponds to the BET input device of the present invention.

It should be noted that the “RESCUE BET” will be described later by using FIG. 5.

The main CPU 41 shifts the processing to step S15 when determining that the “RESCUE BET” has not been placed.

On the other hand, when the main CPU 41 determines that the “RESCUE BET” has been placed, the main CPU 41 conducts the processing of subtracting a previously determined number of credits required for the “RESCUE BET” from the number of credits stored in the RAM 43.

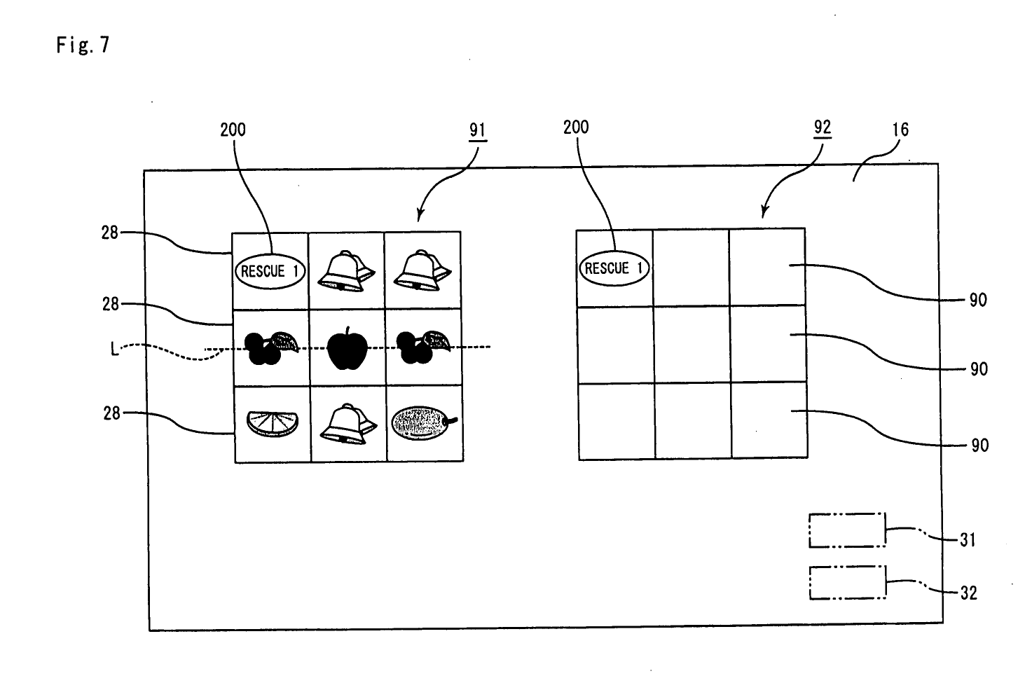

Next, in step S14, the main CPU 41 displays a second display portion 92 to a lower image display panel 16 (see FIG. 3). The second display portion 92 is for conducting a game using a first rescue symbol 200 (see FIG. 7) and the like, the game being different from a game in which symbols are rearranged in a first display portion 91 (see FIG. 3); the descriptions of the game will be given later.

The main CPU 41 then determines whether or not a spin button 23 (see FIG. 3) has been turned ON, in step S15. In the processing, the main CPU 41 determines whether or not to have received an input signal that is output from a start switch 23S (see FIG. 13) when the spin button 23 has been pressed.

The main CPU 41 returns the processing to step S10 when the main CPU 41 determines that the spin button 23 has not been turned ON. It should be noted that the main CPU 41 cancels the subtraction result obtained in step S11 when the spin button 23 has not been turned ON (for example, when a command for terminating the game has been input without the spin button 23 being turned ON).

On the other hand, when the main CPU 41 determines that the spin button 23 has been turned ON, the main CPU 41 shifts the processing to step S16.

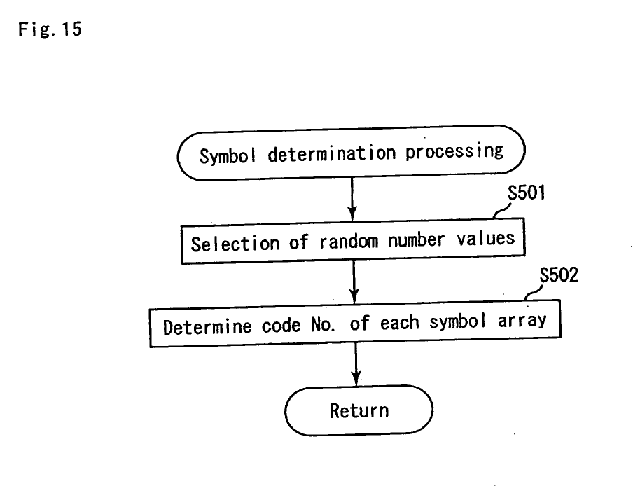

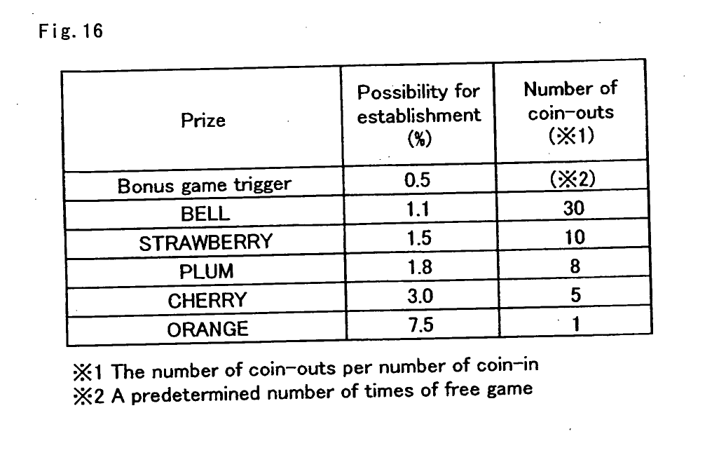

The main CPU 41 then conducts symbol determination processing (step S16). In the symbol determination processing, the main CPU 41 determines code Nos. in stopping the symbols in the first display portion 91 by conducting a symbol determination program stored in the RAM 43. This leads to determination of symbols to be stop-displayed. The processing will be described later in detail by using FIG. 15 and FIG. 16. It should be noted that a case will be described in which one prize is determined out of a plurality of types of prizes by determining a combination of symbols to be stop-displayed; however, in the present invention, for example, one prize to be selected out of the plurality of types of prizes may be determined first, and thereafter a combination of symbols to be stop-displayed may be determined based on the prize.

Next, the main CPU 41 conducts scroll-display control processing (step S17). The processing is for stopping, after scrolling of symbols has started, the scroll-display to each display block 28 (see FIG. 3) in the first display portion 91 so that the combination of the symbols corresponding to the prize determined in step S16 is stop-displayed along a winning line L (see FIG. 3).

In step S18, the main CPU 41 then determines whether or not the first rescue symbol 200 has been stopped in any of the display blocks 28 in the first display portion 91. When the main CPU 41 determines that the first rescue symbol 200 has not been stopped, the main CPU 41 shifts the processing to step S21. The first rescue symbol 200 corresponds to the first specific symbol in the present invention.

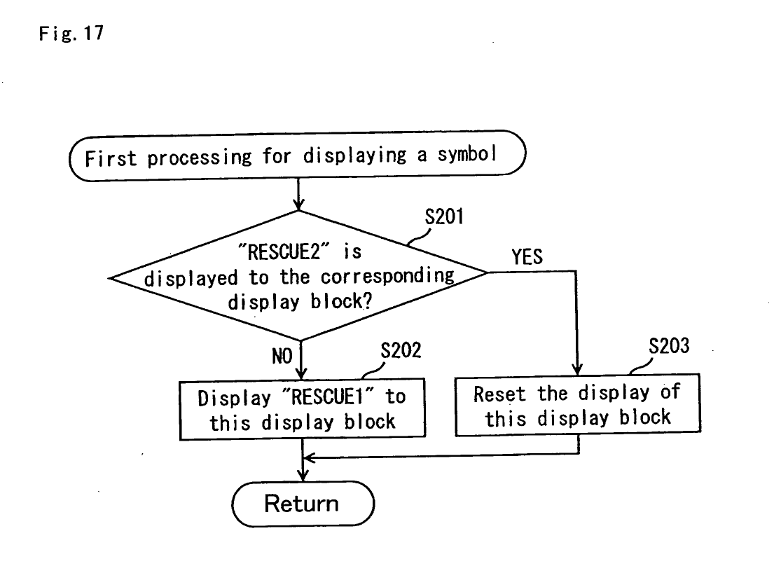

On the other hand, when the main CPU 41 determines that the first rescue symbol 200 has been stopped, the main CPU 41 conducts, in step S19, first processing of displaying a symbol. In the first processing of displaying a symbol, to a display block 90 in the second display portion 92 corresponding to the display block 28 to which a first rescue symbol 200 has been displayed, the first rescue symbol 200 is displayed; the detailed descriptions of the processing will be given later by using FIG. 17.

It should be noted that the first rescue symbol 200 is additionally displayed to the second display portion 92 every time it is stopped in the first display portion 91.

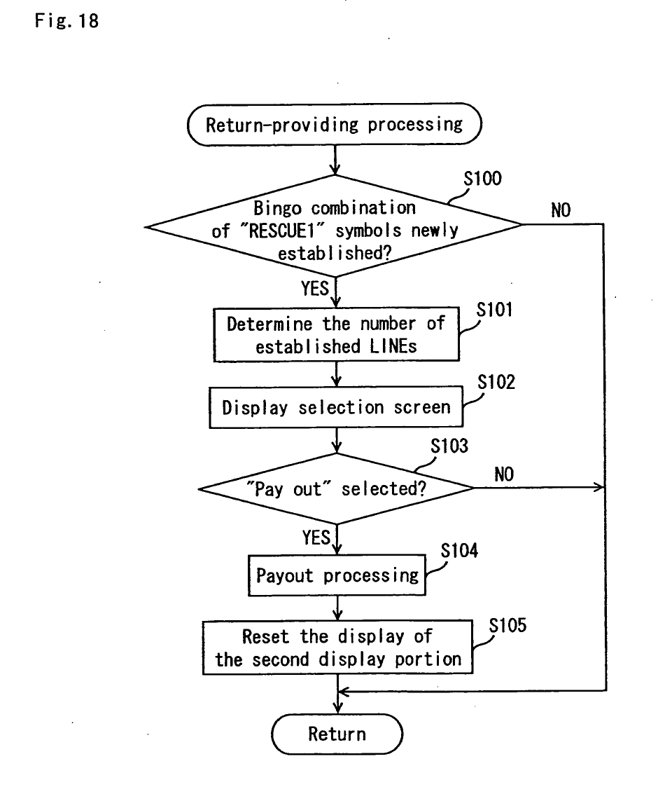

Next in step S20, the main CPU 41 conducts return-providing processing. The return-providing processing is for determining whether or not a bingo combination of the first rescue symbols 200 has been established in the second display portion 92, and conducting a payout based on the determination. The detailed descriptions of the return-providing processing will be given later by using FIG. 18.

The main CPU 41 then determines whether or not a combination of bonus game triggers has been established, i.e., whether or not three “APPLE” symbols have been stop-displayed along the winning line L (step S21). When the main CPU 41 determines that a combination of bonus game triggers has been established, the main CPU 41 resets the display of the first rescue symbol 200 in the second display portion 92 (step S22). In the processing, the main CPU 41 also transmits a reset signal indicating that the display of the first rescue symbol 200 in the second display portion 92 has been reset, to a server 400 included in the gaming system 500.

Upon receipt of the reset signal, the server 400 transmits to the other slot machines 10 a reset-commanding signal commanding to reset a display of a second rescue symbol 201 (described later) in the corresponding display block 90. In the above-mentioned other slot machines 10 that have received the reset-commanding signal, the display of the second rescue symbol 201 in the corresponding display block 90 is reset.

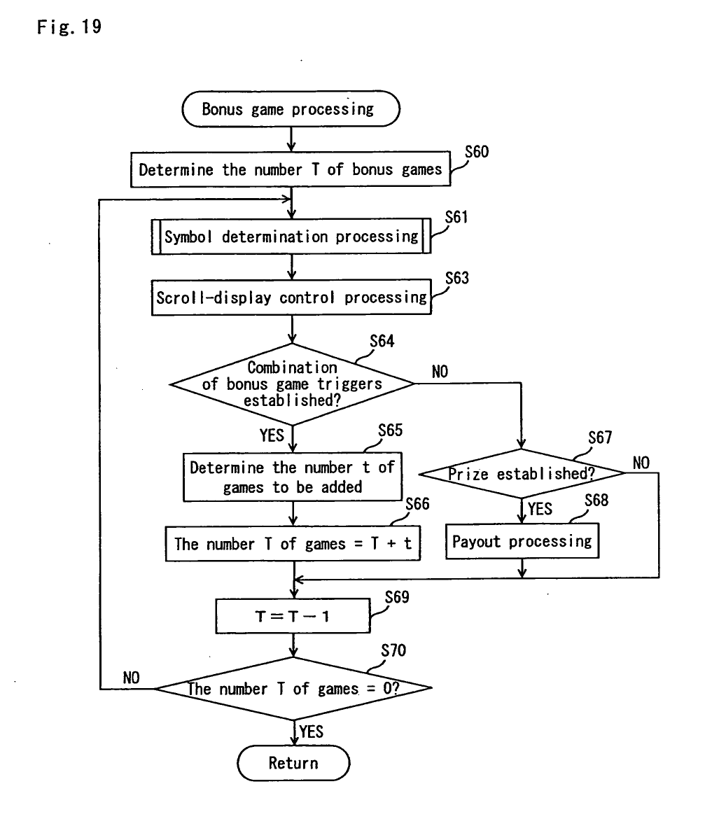

Next, the main CPU 41 reads from the RAM 43 a program for conducting a bonus game so as to conduct bonus game processing (step S23). The detailed descriptions of the bonus game processing will be given later by using FIG. 19. After conducting the processing of step S23, the main CPU 41 terminates the present subroutine.

On the other hand, when the main CPU 41 determines in step S21 that a combination of bonus game triggers has not been established, the main CPU 41 determines whether or not a prize has been established (step S24). When the main CPU 41 determines that a prize has not been established, the main CPU 41 terminates the present subroutine.

On the other hand, when the main CPU 41 determines that a prize has been established, the main CPU 41 pays out coins according to the inserted coins and the prize (step S25). When accumulation of coins is to be conducted, the main CPU 41 conducts processing of making an addition to the number of credits stored in the RAM 43. Meanwhile, when a payout of coins is to be conducted, the main CPU 41 transmits a control signal to a hopper 66 (see FIG. 13) in order to pay out coins. The award provided (payout of coins) in step S25 corresponds to the normal award in the present invention.

Next, in step S26, the main CPU 41 determines whether or not the payout in step S25 is a predetermined amount or more.

When the main CPU 41 determines that the amount of the payout is less than the predetermined amount, the main CPU 41 terminates the present subroutine.

On the other hand, when the main CPU 41 determines that the amount of the payout is the predetermined amount or more, the main CPU 41 resets the display of the first rescue symbol 200 in the second display portion 92 (step S27). In the processing, the main CPU 41 also transmits a reset signal indicating that the display of the first rescue symbol 200 in the second display portion 92 has been reset, to the server 400 included in the gaming system 500.

After conducting the processing of step S27, the main CPU 41 terminates the present subroutine.

FIG. 2 is a diagrammatic view illustrating an entire configuration of a gaming system according to the present embodiment.

The gaming system 500 is provided with a plurality of slot machines 10, and the server 400 connected through a predetermined communication line 501 to those slot machines 10. The plurality of slot machines 10 configuring the gaming system 500 are capable of communicating with one another through the communication line 501 and the server 400. Such a gaming system 500 may either be structured within a single recreation facility that can offer various types of games, such as a bar and a casino, or structured among a plurality of recreation facilities. Also, in the case where the gaming system 500 is structured within a single recreation facility, the gaming system 500 may be structured on each floor or in each section in this recreation facility. There is no particular limitation on the communication line 501, but the communication line 501 may be of a wired type or a wireless type and, may be a dedicated line, switched line and the like.

Next, the configuration of the slot machine 10 according to the present embodiment will be described.

FIG. 3 is a perspective view illustrating an external view of a slot machine according to the present invention.

In the slot machine 10, a coin, a bill, or electronic valuable information corresponding to those is used as a game medium. However, the game medium in the present invention is not particularly limited thereto; examples of the game medium include a medal, a token, electronic money, and a ticket. It should be noted that the above-mentioned ticket is not particularly limited, and examples thereof may include a ticket with a barcode as described later.

The slot machine 10 is equipped with a cabinet 11, a top box 12 installed on the upper side of the cabinet 11, and a main door 13 provided at the front face of the cabinet 11.

The lower image display panel 16 as a display is provided on the main door 13. The lower image display panel 16 has a transparent liquid crystal panel to which the first display portion 91 consisting of 9 display blocks 28 in 3 rows and 3 columns and the second display portion 92 consisting of 9 display blocks 90 in 3 rows and 3 columns are displayed. To each of the display blocks 28 and 90, one symbol is to be displayed.

Further, a number-of-credits display portion 31 and a number-of-payouts display portion 32 are arranged in the lower image display panel 16. The number of credited coins is displayed, as an image, to the number-of-credits display portion 31. The number of coins to be paid out is displayed, as an image, to the number-of-payouts display portion 32.

Moreover, at the front face of the lower image display panel, although not shown, the touch panel 69 is provided so that a player can operate the touch panel 69 to input various types of commands.

Below the lower image display panel 16, there are provided a control panel 20 consisting of a plurality of buttons 23 to 27 with each of which the player inputs a command according to the progress of a game, a coin receiving slot 21 which accepts a coin into the cabinet 11, and a bill validator 22.

The control panel 20 is provided with the spin button 23, a change button 24, a CASHOUT button 25, the 1-BET button 26, and the maximum BET button 27. The spin button 23 is used for inputting a command to start scrolling of symbols. The change button 24 is used for making a request of staff in the recreation facility for exchange. The CASHOUT button is used for inputting a command to pay out credited coins to a coin tray 18.

The 1-BET button 26 is used for inputting a command to bet one coin on a game out of credited coins. The maximum BET button 27 is used for inputting a command to bet a maximum number of coins that can be bet on one game (50 coins in the present embodiment) out of credited coins.

The bill validator 22 not only discriminates a regular bill from a false bill, but also accepts the regular bill into the cabinet 11. It should be noted that the bill validator 22 may be configured so as to be able to read a later-described ticket 39 with a barcode. At the lower front face of the main door 13, namely below the control panel 20, a belly glass 34 having a character or the like of the slot machine 10 drawn thereon is provided.

At the front face of the top box 12, an upper image display panel 33 is provided. The upper image display panel 33 has a liquid crystal panel to display, for example, an image showing introduction of the game contents and explanation of a rule of the game.

Further, a speaker 29 is installed in the top box 12. Below the upper image display panel 33, there are provided a ticket printer 35, a card reader 36, a data display 37, and a key pad 38. The ticket printer 35 is used for printing on a ticket a barcode as coded data of the number of credits, date, an identification number of the slot machine 10, and the like, and outputs the ticket as a ticket 39 with a barcode. The player can make another slot machine 10 read the ticket 39 with a barcode so as to play games thereon, or exchange the ticket 39 with a barcode with a bill or the like at a predetermined place in the recreation facility (for example, a cashier in a casino).

The card reader 36 reads data from a smart card and writes data into the smart card. The smart card is owned by the player, and for example, data for identifying the player, data relating to a history of games played by the player are stored therein. Data corresponding to a coin, a bill, or a credit may be stored into the smart card. Further, in place of a smart card, a magnetic stripe card may be adopted. The data display 37 is comprised of a fluorescent display or the like, and displays, for example, data read by the card reader 36 and data input by the player via the key pad 38. The key pad 38 is used for inputting a command and data relating to the issue of a ticket and the like.

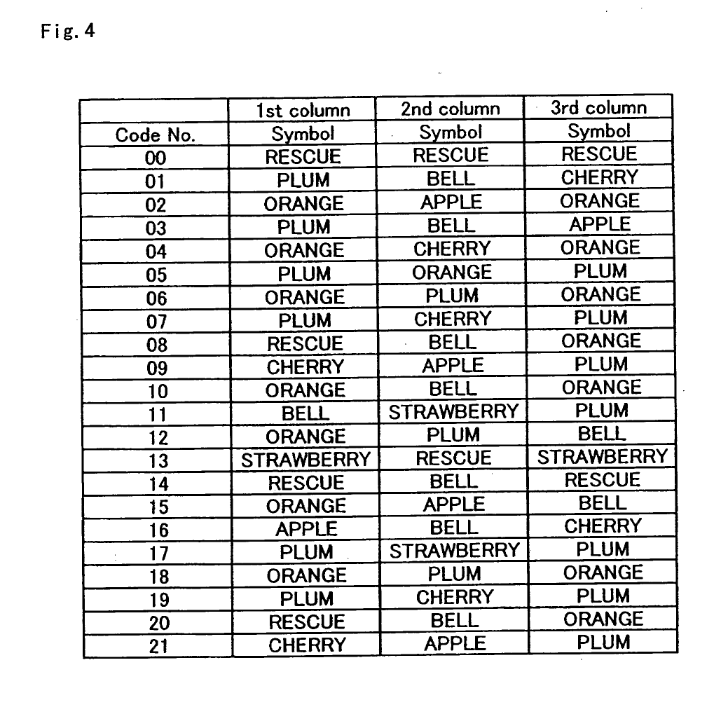

FIG. 4 is a schematic view illustrating arrays of symbols displayed to the respective display blocks.

As described above, the first display portion 91 consisting of 9 display blocks 28 in 3 rows and 3 columns is displayed to the lower image display panel 16, and one symbol is to be displayed to each of the display blocks 28.

As illustrated in FIG. 4, symbol arrays consisting of a total of 22 symbols are respectively scrolled on the 3 symbol columns of the display blocks 28, the symbols being associated with the respective code numbers of “00” to “21”. Each of the symbol arrays consists of a combination of “RESCUE”, “BELL”, “STRAWBERRY”, “PLUM”, “CHERRY”, “ORANGE”, and “APPLE” symbols.

When three symbols of the same type out of “BELL”, “STRAWBERRY”, “PLUM”, “CHERRY”, and “ORANGE” are stop-displayed along the winning line L, a predetermined number of coins are paid out (see FIG. 16).

“APPLE” is a bonus game trigger (a symbol that makes the shift to a bonus game) . When three “APPLE” symbols are stop-displayed along the winning line L, the game is shifted to a bonus game. In the present embodiment, a bonus game is a free game (a game that can be played for a predetermined number of times, without placing a BET of coins).

The symbol “RESCUE” represents the first rescue symbol 200 in each of the slot machines 10, and the symbol is not associated with a payout in games in the first display portion 91. When “RESCUE” has stopped, as the first rescue symbol 200, in any of the display blocks 28 forming the first display portion 91, the first rescue symbol 200 is displayed to the corresponding display block 90 in the second display portion 92 (see FIG. 7).

When the spin button 23 is pressed to start a game after the 1-BET button 26 or the maximum BET button 27 has been pressed, symbols displayed to the respective display blocks 28 are scroll-displayed downwardly. Then, symbols are rearranged after elapse of a predetermined time. Further, various types of prizes (see FIG. 16) are previously determined based on the respective symbol combinations; when a symbol combination corresponding to a prize stops along a winning line L, the number of coin-outs according to the prize is added to the credits owned by the player. Furthermore, a bonus game is generated when a combination of bonus game triggers has been established.

It should be noted that, in the present embodiment, a case has been described in which the symbols displayed to the display blocks 28 are automatically rearranged after a predetermined time has passed since scroll-display of the symbols. However, the condition for stopping the symbols is not particularly limited; for example, the slot machine 10 may be provided with a stop button, and the symbols may be rearranged when the stop button is pressed.

Next, descriptions will be given for the images displayed to the lower image display panel 16 of the slot machine 10.

FIGS. 5 to 12 each is a view illustrating an exemplary image displayed to a lower image display panel.

FIG. 5 is an exemplary image displayed to the lower image display panel 16 before start of a game in the first display portion 91.

As illustrated in FIG. 5, the first display portion 91 consisting of 9 display blocks 28 is displayed on the left side of the lower image display panel 16, and on the right side thereof, an image 100 prompting the player to select whether or not to place the “RESCUE BET” is displayed. The image 100 includes a button image 101 for placing the “RESCUE BET” and a button image 102 for not placing the “RESCUE BET”. The player can touch an area corresponding to the button image 101 or the button image 102 on the touch panel 69 to input a selection of whether or not to place the “RESCUE BET”.

The “RESCUE BET” is a BET required for conducting a game for providing relief for the player who cannot acquire a payout in a game in the first display portion 91 (a game in the second display portion 92), separately from a game in the first display portion 91. When the “RESCUE BET” is placed, a predetermined number of credits is subtracted from the credits owned by the player.

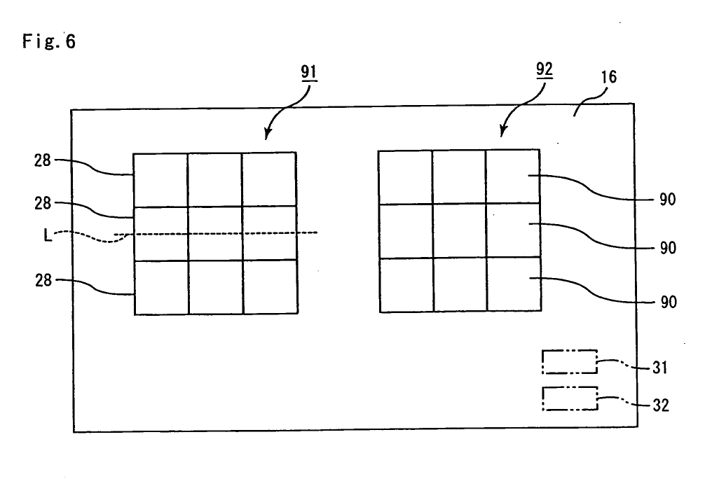

FIG. 6 is an exemplary view displayed to the lower image display panel 16 when the “RESCUE BET” is placed.

As illustrated in FIG. 6, the second display portion 92 consisting of 9 display blocks 90 is displayed on the right side of the first display portion 91 when the “RESCUE BET” is placed.

FIG. 7 is a view shown when the first rescue symbol 200 is rearranged to one of the display blocks 28 in the first display portion 91.

As shown in FIG. 7, the first rescue symbol 200 is rearranged to the display block 28 on the upper left portion of the first display portion 91, and the first rescue symbol 200 is displayed to the display block 90 corresponding to this display block 28 (the display block 90 on the upper left portion of the second display portion 92). As described above, the first rescue symbol 200 is additionally displayed to the second display portion 92 every time it is rearranged in the first display portion 91.

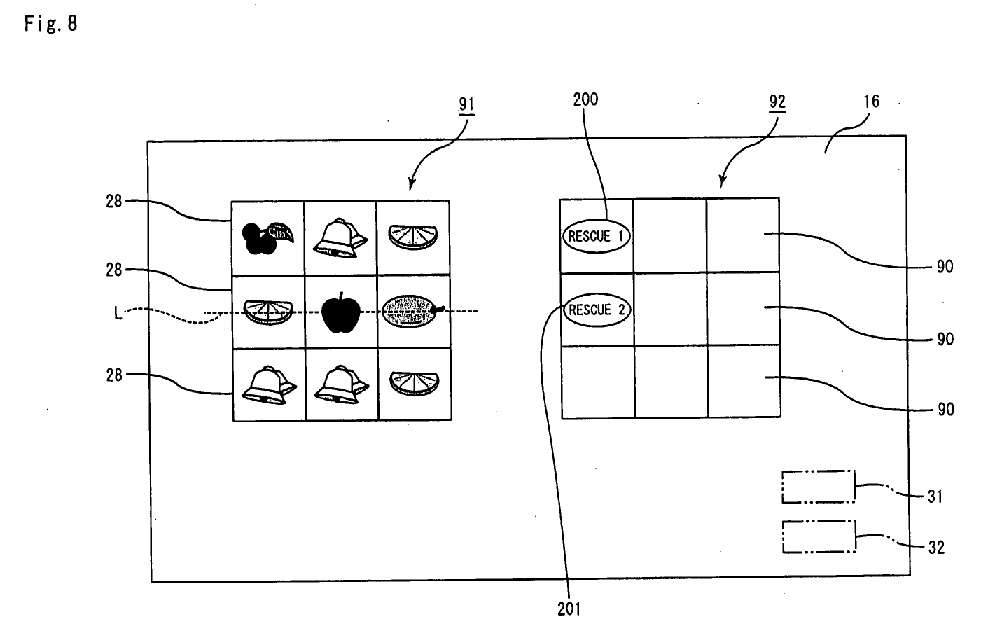

FIG. 8 is an exemplary view shown when the second rescue symbol 201 is displayed in the second display portion 92.

In the present embodiment, when the first rescue symbol 200 is rearranged to a first display portion of any of the slot machines 10 configuring the gaming system 500, the second rescue symbol 201 is displayed to the corresponding display block 90 in a second display portion 92 in each of the slot machines 10 other than this slot machine 10. The second rescue symbol 201 corresponds to the second specific symbol in the present invention.

As shown in FIG. 8, the second rescue symbol 201 is displayed to the leftmost display block 90 in the middle row of the second display portion 92. This indicates that the first rescue symbol 200 has been rearranged to a leftmost display block 28 in the middle row of a first display portion 91 in any of the other slot machines 10. It should be noted that, in the above-mentioned slot machine 10 in which the first rescue symbol 200 has been rearranged, the first rescue symbol 200 is displayed to the leftmost display block 90 in the middle row of the second display portion 92.

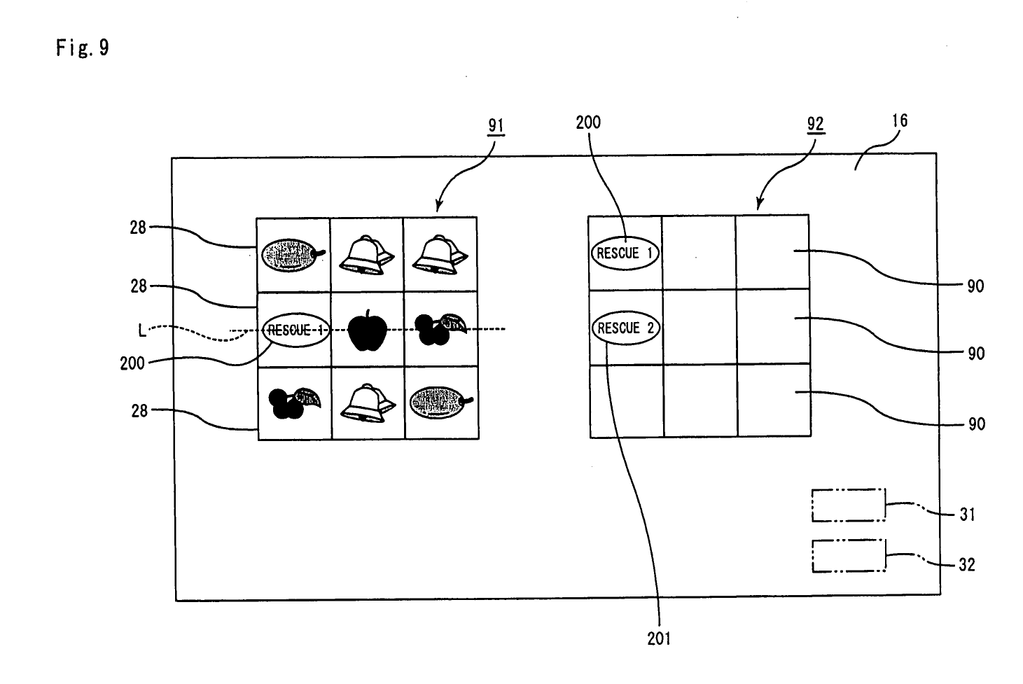

FIG. 9 is a view shown in the case where the second rescue symbol 201 has been displayed to the display block 90 in the second display portion 92 and the first rescue symbol 20b is rearranged to the corresponding display block 28 in the first display portion 91.

As illustrated in FIG. 9, in the situation where the second rescue symbol 201 has been displayed to the leftmost display block 90 in the middle row of the second display portion 92, the first rescue symbol 200 is rearranged to the leftmost display block 28 in the middle row of the first display portion 91.

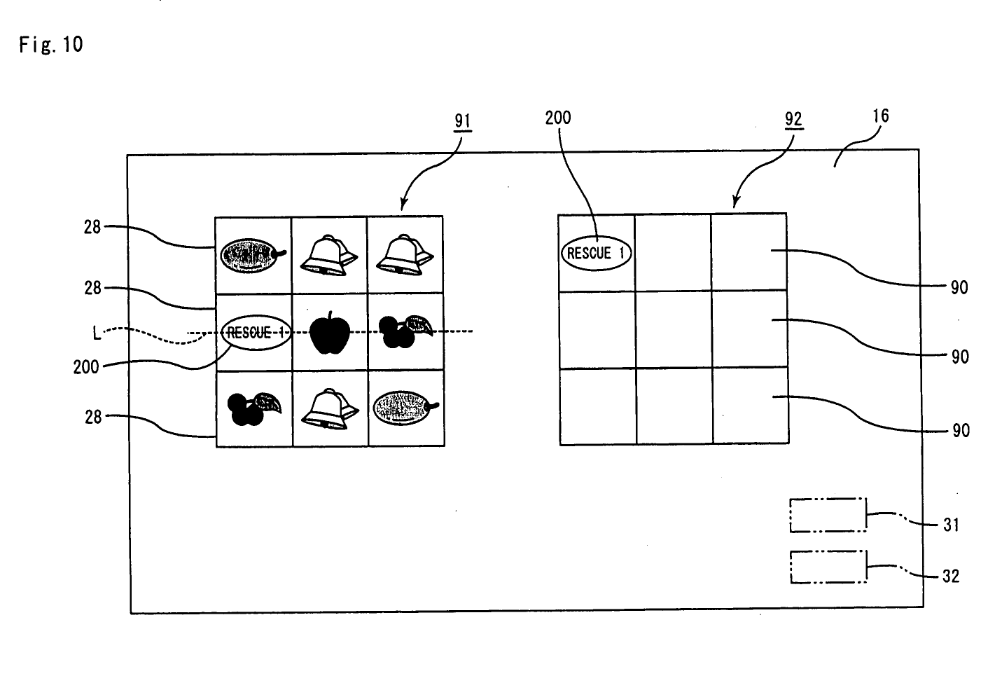

In such a case, the display of the second rescue symbol 201 that has been displayed to the display block 90 is reset so that any symbol is not displayed to this display block 90, as illustrated in FIG. 10. At this time, the display of the symbol (the first rescue symbol 200 or the second rescue symbol 201) that has been displayed to the corresponding display block 90 (the leftmost display block 90 in the middle row of the second display portion 92) in the other slot machines 10 is also reset.

As described above, rearrangement of the first rescue symbol 200 in the display block 28 corresponding to the display block 90 to which the second rescue symbol 201 is displayed makes it possible to delete this second rescue symbol 201, namely the symbol derived from another slot machine 10.

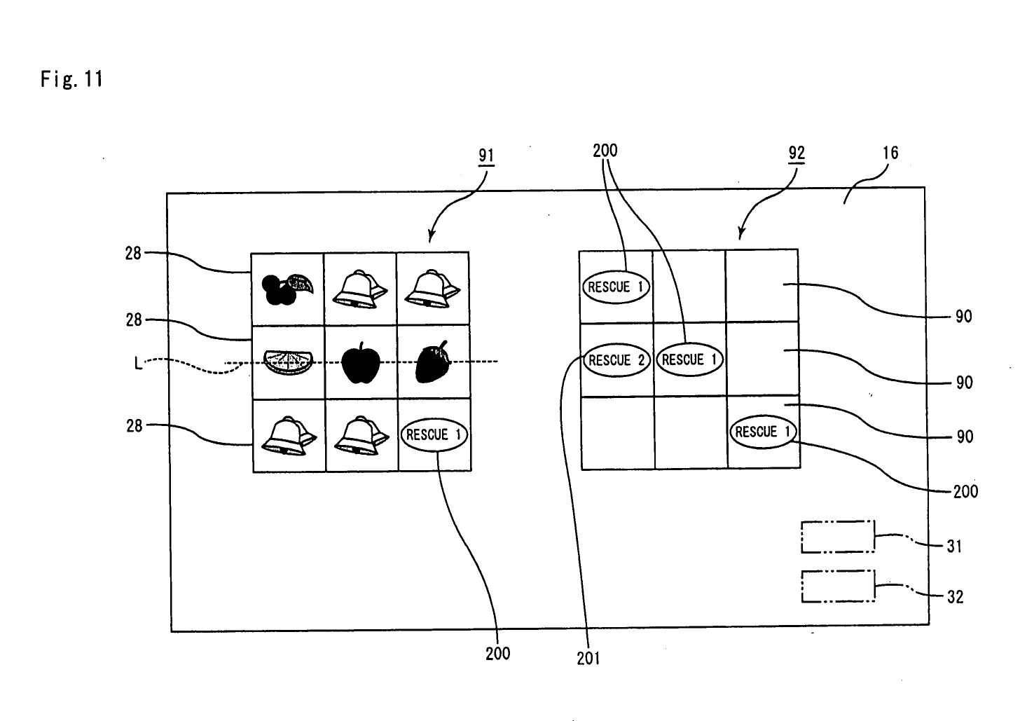

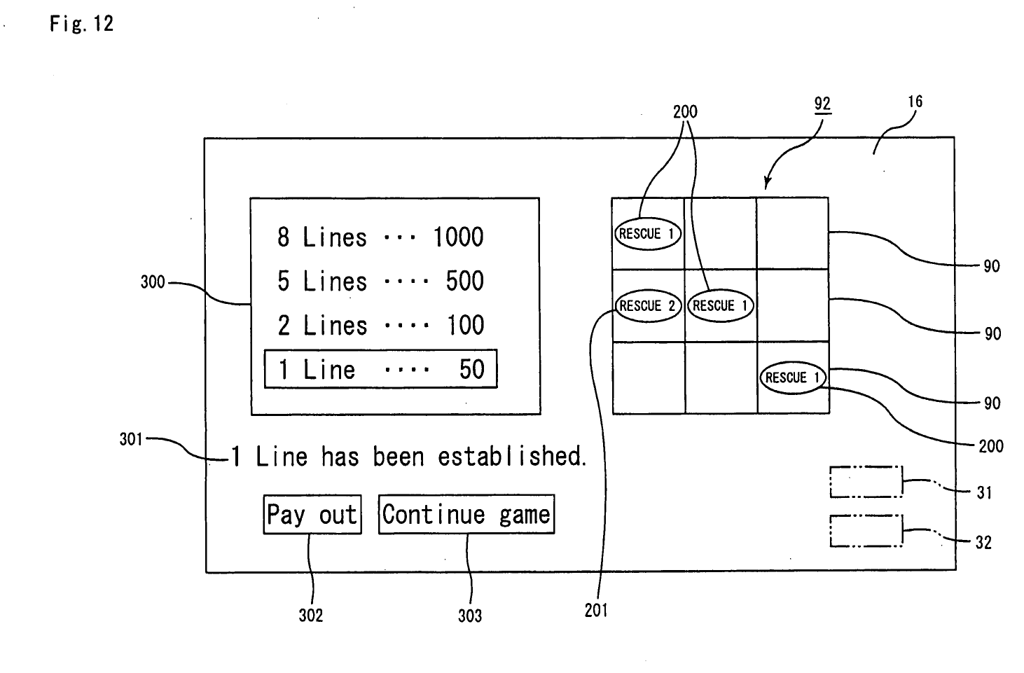

FIG. 11 and FIG. 12 are views shown when a bingo combination of the first rescue symbols 200 is established in the second display portion 92.

As shown in FIG. 11, the first rescue symbol 200 rearranged to the display block 28 on the lower right portion of the first display portion 91 has led to a display of the first rescue symbol 200 to the corresponding display block 90 (the display block 90 on the lower right portion in the second display portion 92), whereby the first rescue symbol 200 is displayed to all the 3 display blocks 90 in a diagonal of the second display portion 92, resulting in establishment of a bingo state.

In the case where such a bingo state is established as a result of proceeding with the game by following the above-described rule, the player can receive a payout according to the established bingo combination, as described below.

As shown in FIG. 12, a bingo combination of the first rescue symbols 200 is established in a diagonal of the second display portion 92. On the left side of the second display portion 92, an image 300 is displayed which illustrates a relationship between the number of LINEs of established bingo combinations and the amount of payout to be offered. Below the image 300 is displayed an image 301 notifying the player that one LINE has been established. Further, below the image 301, there are displayed button images 302 and 303 for selecting whether to receive a payout (50 coins, which corresponds to 1 LINE) at this point, or to continue on games without receiving the payout at this point.

The player can receive the payout by touching on the touch panel 69 the place corresponding to the button image 302, and continue on games by touching on the touch panel 69 the place corresponding to the button image 303. The touch panel 69 corresponds to the selection input device in the present invention.

When a new bingo combination is established (for example, in a case in which a bingo combination is established on one column) after the continuation of games has been selected, there is displayed an image corresponding to the number of LINEs being established at this point, in the same manner as in FIG. 12; when a payout has been selected, a payout is conducted according to the number of LINEs.

FIG. 13 is a block diagram illustrating an internal configuration of the slot machine illustrated in FIG. 3.

A gaming board 50 includes: a CPU (Central Processing Unit) 51, a ROM 55 and a boot ROM 52 that are interconnected to one another by an internal bus; a card slot 53S corresponding to a memory card 53; and an IC socket 54S corresponding to a GAL (Generic Array Logic) 54.

The memory card 53 is comprised of a nonvolatile memory such as CompactFlash (registered trademark) and stores game programs. The game programs include a symbol determination program. The symbol determination program is for determining symbols (code Nos. corresponding to the symbols) to be rearranged to the display blocks 28.

Further, the card slot 53S is configured to allow the memory card 53 to be inserted thereinto or ejected therefrom an disconnected to a mother board 40 by an IDE bus. Accordingly, the memory card 53 can be ejected from the card slot 53S in order to write another game program into the memory card 53, and then the memory card 53 can be inserted into the card slot 53S to change the types and the contents of games played in the slot machine 10. The game programs include programs relating to progresses of games. Further, the game programs include image data and sound data that are output during games.

The CPU 51, the ROM 55, and the boot ROM 52 interconnected to one another by the internal bus are connected to the mother board 40 by a PCI bus. The PCI bus not only conducts signal transmission between the mother board 40 and the gaming board 50, but also supplies electric power to the gaming board 50 from the mother board 40.

The mother board 40 is comprised of a general-purpose mother board (a printed circuit board on which basic components of a personal computer are mounted), and is provided with the main CPU 41, a ROM (Read Only Memory) 42, a RAM (Random Access Memory) 43, and a communication interface 44. The mother board 40 corresponds to the controller in the present invention.

The ROM 42 is comprised of a memory device such as flash memory, and stores programs such as BIOS (Basic Input/Output System) executed by the main CPU 41, and permanent data. When BIOS is executed by the main CPU 41, not only is processing for initializing predetermined peripheral devices conducted, but also processing for loading the game program stored in the memory card 53 is conducted through the gaming board 50. It should be noted that, in the present invention, the ROM 42 may or may not be a data rewritable one.

The RAM 43 stores data and programs to be used at the time of operation of the main CPU 41. Further, the RAM 43 is capable of storing game programs.

Moreover, the RAM 43 stores data such as the number of credits, the numbers of coin-ins and coin-outs in one game.

The mother board 40 is connected with a later-described body PCB (Printed Circuit Board) 60 and a door PCB 80 through respective USBs. Further, a power supply unit 45 is connected to the mother board 40.

The body PCB 60 and the door PCB 80 are connected with equipment and devices that generate an input signal to be input to the main CPU 41, and equipment and devices the operations of which are controlled by a control signal output from the main CPU 41. The main CPU 41 conducts a game program stored in the RAM 43 based on the input signal input in the main CPU 41, thereby conducting predetermined arithmetic processing, storing the result thereof into the RAM 43, and transmitting a control signal to the respective equipment and devices as processing for controlling the respective equipment and devices.

The body PCB 60 is connected with a lamp 30, the hopper 66, a coin detecting portion 67, a graphic board 68, a speaker 29, the touch panel 69, the bill validator 22, the ticket printer 35, the card reader 36, a key switch 38S, and the data display 37. The lamp 30 is lighted in a predetermined pattern based on a control signal output from the main CPU 41.

The hopper 66 is installed inside the cabinet 11, and pays out a predetermined number of coins from a coin payout exit 19 to a coin tray 18, based on a control signal output from the main CPU 41. The coin detecting portion 67 is installed inside the coin payout exit 19, and outputs an input signal to the main CPU 41, when detecting a payout of a predetermined number of coins from the coin payout exit 19.

The graphic board 68 controls image display in the upper image display panel 33 and the lower image display panel 16, based on a control signal output from the main CPU 41. In each of the display blocks 28 in the lower image display panel 16, there are displayed a background color determined by a random number selection, and a symbol being scrolled or stopped. The number of credits stored in the RAM 43 is displayed to the number-of-credits display portion 31 in the lower image display panel 16. Further, the number of coin-outs is displayed to the number-of-payouts display portion 32 in the lower image display panel 16.

The graphic board 68 is provided with a VDP (Video Display Processor) for generating image data based on a control signal output from the main CPU 41, a video RAM for temporarily storing image data generated by the VDP, and the like. Here, the image data used in generation of the image data by the VDP is included in the game program read from the memory card 53 and stored into the RAM 43.

The bill validator 22 not only discriminates a regular bill from a false bill, but also accepts the regular bill in the cabinet 11. Upon acceptance of the regular bill, the bill validator 22 outputs an input signal to the main CPU 41, based on the face amount of the bill. The main CPU 41 stores into the RAM 43 the number of credits according to the face amount of the bill transmitted with the input signal.

The ticket printer 35 prints on a ticket a barcode formed by encoding data of the number of credits stored in the RAM 43, date, an identification number of the slot machine 10 and the like based on a control signal output from the main CPU 41, and outputs the ticket as a ticket 39 with a barcode. The card reader 36 reads data from a smart card and transmits the data to the main CPU 41, and writes data into the smart card based on a control signal from the main CPU 41. The key switch 38S is provided on the key pad 38, and outputs a predetermined input signal to the main CPU 41 when the key pad 38 is operated by the player. The data display 37 displays data read by the card reader 36 and data input by the player via the key pad 38, based on a control signal output from the main CPU 41.

The door PCB 80 is connected with a control panel 20, a reverter 21S, a coin counter 21C, and a cold cathode tube 81. The control panel 20 is provided with the start switch 23S corresponding to the spin button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. The respective switches 23S to 27S output an input signal to the main CPU 41 when each of the buttons 23 to 27 corresponding thereto is operated by the player.

The coin counter 21C is provided inside the coin receiving slot 21 so as to discriminate a regular coin from a false coin inserted into the coin receiving slot 21 by the player. A coin other than the regular coin is discharged from the coin payout exit 19. Further, the coin counter 21C outputs an input signal to the main CPU 41, upon detection of a regular coin.

The reverter 21S operates based on a control signal output from the main CPU 41, and distributes the coin recognized by the coin counter 21C as a regular coin into a cashbox (not shown) or the hopper 66 that are installed inside the slot machine 10. More specifically, the reverter 21S distributes the regular coin into the cashbox when the hopper 66 is filled with coins; on the other hand, the reverter 21S distributes the regular coin into the hopper 66 when the hopper 66 is not filled with coins. The cold cathode tube 81 functions as a back light installed on the rear face side of the lower image display panel 16 and the upper image display panel 33, and is lighted based on a control signal output from the main CPU 41.

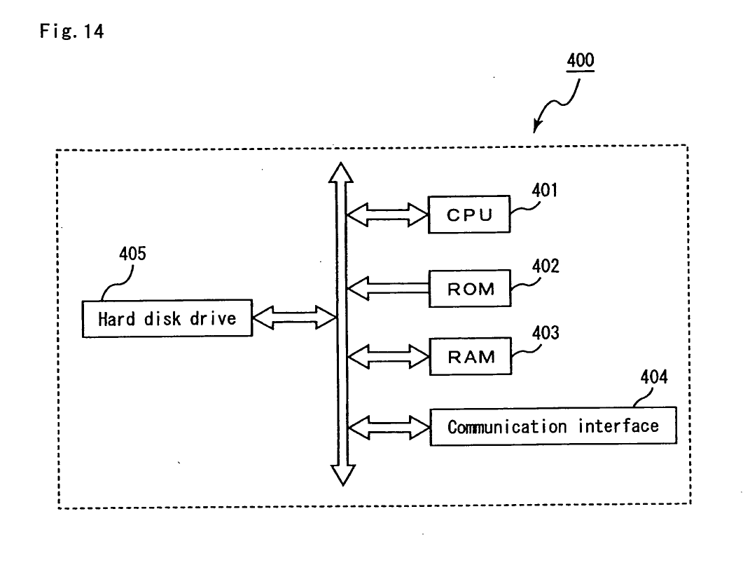

FIG. 14 is a block diagram illustrating an internal configuration of a server according to the present embodiment,

The server 400 is provided with a CPU 401, a ROM 402, a RAM 403, a communication interface 404, and a hard disk drive 405 as a memory. The communication interface 404 is connected with a communication interface 44 of each of the slot machines 10, through the communication line 501. In the ROM 402, system programs for controlling operation of the controller, permanent data, and the like are stored. Further, the RAM 403 temporarily stores data received from each of the slot machines 10.

Next, processing conducted in the slot machine 10 will be described.

The main CPU 41 proceeds with the game by reading the game program and executing it.

Since the game execution processing has been already described by using FIG. 1, descriptions thereof will be omitted here.

FIG. 15 is a flowchart illustrating a subroutine of the symbol determination processing invoked and executed in step S16 in the subroutine illustrated in FIG. 1. To conduct the processing, the main CPU 41 executes the symbol determination program stored in the RAM 43.

First, the main CPU 41 executes a random number generation program included in the symbol determination program, to select random number values corresponding to the respective symbol arrays out of the numbers falling in the numeric value range of 0 to 255 (step S501). In the present embodiment, a case is described in which random numbers are generated on the program (a case of using a so-called software random number). However, in the present invention, a random number generator may be provided and random numbers may be extracted from the random number generator (a case of using a so-called hardware random number).

Next, the main CPU 41 determines code Nos. of the respective symbol arrays (see FIG. 4) based on selected 3 random numbers (step S502). The code Nos. of the respective symbol arrays correspond to the code Nos. of symbols to be stop-displayed along the winning line L. The main CPU 41 determines code Nos. of the respective symbol arrays so as to determine a combination of symbols, thereby determining a prize based on the combination. For example, determining to set “11”, “14”, and “15” as code Nos. of the respective symbols means that the main CPU 41 has determined to set a combination of three “BELL” symbols, i.e., determined to set a prize of “BELL”.

Here, prizes in the present embodiment will be described.

FIG. 16 is a view illustrating relations among a plurality of types of prizes, the probability for establishment of each prize and the number of payouts.

When three “APPLE” symbols are rearranged along the winning line L and a combination of bonus game triggers is established, a bonus game is generated. In a bonus game, a predetermined number of free games are executed based on random numbers acquired by executing the random number generation program included in the symbol determination program.

Further, when three “BELL” symbols are rearranged along the winning line L, 30 coins are paid out per inserted coin. Similarly, when three symbols of the same type out of “STRAWBERRY”, “PLUM”, “CHERRY”, and “ORANGE” are rearranged along the winning line L, coins in a number corresponding to the respective prizes of combinations are paid out.

It should be noted that, in the present embodiment, a payout is determined based on a combination of symbols rearranged along the winning line L; however, in the present invention, a method for determining a normal award is not limited to this example. For example, an award may be determined according to the types of symbols rearranged to the display blocks, or based on whether or not symbols of a specific type are rearranged to the display blocks.

FIG. 17 is a flowchart illustrating a subroutine of first processing of displaying a symbol.

The first processing of displaying a symbol is invoked and executed in step S19 of the subroutine shown in FIG. 1.

First, in step S201, the main CPU 41 determines whether or not the second rescue symbol 201 has been already displayed to the display block 90 corresponding to the display block 28 to which the first rescue symbol 200 is rearranged.

When the main CPU 41 determines that the second rescue symbol 201 has not been displayed to the corresponding display block 90, the main CPU 41 displays, in step S202, the first rescue symbol 200 to this display block 90. In the processing, the main CPU 41 also transmits to the server 400 a symbol display signal indicating that the first rescue symbol 200 has been displayed to the display block 90.

Upon receipt of the symbol display signal, the server 400 transmits to the other slot machines 10 a symbol-display commanding signal commanding to display the second rescue symbol 201 to the corresponding display block 90. In the above-mentioned other slot machines 10 that have received the symbol-display commanding signal, the second rescue symbol 201 is displayed to the corresponding display block 90.

On the other hand, when the main CPU 41 determines in step S201 that the second rescue symbol 201 has been already displayed to the corresponding display block 90, the main CPU 41 resets in step S203 the display of the second rescue symbol 201 in this display block 90. Namely, the main CPU 41 deletes the second rescue symbol 201 that has been displayed to this display block 90.

In the processing, the main CPU 41 also transmits a reset signal indicating that the display of the second rescue symbol 201 in the second display portion 92 has been reset, to the server 400 included in the gaming system 500.

Upon receipt of the reset signal, the server 400 transmits to the other slot machines 10 a reset-commanding signal commanding to reset the display of the first rescue symbol 200 or the second rescue symbol 201 in the corresponding display block 90. In the above-mentioned other slot machines 10 that have received the reset-commanding signal, the display of the first rescue symbol 200 or the second rescue symbol 201 in the corresponding display block 90 is reset.

After conducting the processing of step S202 or step S203, the main CPU 41 terminates the present subroutine.

FIG. 18 is a flowchart illustrating a subroutine of return-providing processing.

The return-providing processing is invoked and executed in step S20 of the subroutine illustrated in FIG. 1.

First, in step S100, the main CPU 41 determines whether or not a bingo combination of the first rescue symbols 200 has been newly established in the second display portion 92.

When the main CPU 41 determines that a bingo combination of the first rescue symbols 200 has not been newly established, the main CPU 41 terminates the present subroutine.

On the other hand, when the main CPU 41 determines that a bingo combination of the first rescue symbols 200 has been newly established, the main CPU 41 determines in step S101 the number of LINEs of bingo combinations currently being established. More specifically, the main CPU 41 determines the number of LINEs of bingo combinations determined to have been newly established and the number of LINEs of bingo combinations that have been already established so as to calculate the sum of these numbers.

Next, in step S102, the main CPU 41 displays a selection screen to the lower image display panel 16. More specifically, the main CPU 41 displays an image for selecting a payout or continuation of games, such as an image shown in FIG. 8, to the lower image display panel 16.

Then, in step S103, the main CPU 41 determines whether or not an input of selecting a payout has been entered on the selection screen displayed in step S102. When the main CPU 41 determines that an input of selecting a payout has not been entered, the main CPU 41 terminates the present subroutine.

On the other hand, when the main CPU 41 determines that an input of selecting a payout has been entered, the main CPU 41 conducts, in step S104, the processing for providing a payout (coins) according to the sum of the number of LINEs determined in step S101. The payout conducted in step S104 corresponds to the special award in the present invention.

Next, in step S105, the main CPU 41 resets the display of the first rescue symbol 200 and the second rescue symbol 201 in the second display portion 92.

In the processing, the main CPU 41 also transmits a reset signal indicating that the display of the first rescue symbol 200 and the second rescue symbol 201 in the second display portion 92 is reset, to the server 400 included in the gaming system 500.

Upon receipt of the reset signal, the server 400 transmits to the other slot machines 10 a reset-commanding signal commanding to reset the display of the first rescue symbol 200 and the second rescue symbol 201 in the second display portion 92. In the above-mentioned other slot machines 10 that have received the reset-commanding signal, the display of the first rescue symbols 200 and the second rescue symbols 201 in the second display portion 92 is reset.

After executing processing of step S105, the main CPU 41 terminates the present subroutine.

FIG. 19 is a flowchart illustrating a subroutine of bonus game processing.

The bonus game processing is invoked and executed in step S23 of the subroutine shown in FIG. 1.

First, the main CPU 41 determines the number of bonus games from 10 to 25 games, based on a random number acquired by executing the random number generation program included in the symbol determination program stored in the RAM 43 (step S60). The main CPU 41 stores in the RAM 43 the determined number of bonus games as data.

Subsequently, the main CPU 41 conducts symbol determination processing (step S61) and scroll-display control processing (step S63). The processing of step S61 is substantially the same as the processing described by using FIG. 15. Since the processing has been already described, descriptions thereof are omitted here.

Next, the main CPU 41 determines whether or not a combination of bonus game triggers has been established, i.e., whether or not three “APLLE” symbols have been displayed along the winning line L (step S64). When the main CPU 41 determines that a combination of bonus game triggers has been established, a number t of bonus game repetition times is newly determined (step S65), and the determined number t of bonus game repetition times is added to a current number T of bonus games (step S66). Therefore, when a bonus game has been won during a bonus game, the remaining number of bonus games is increased. More specifically, for example, in a case in which a game state shifts to 20 bonus games for the first time, when 17 bonus games are won in the 12th bonus game, another 25 bonus games (20 bonus games−12 bonus games+17 bonus games) are to be executed.

When a combination of bonus game triggers has not been established, the main CPU 41 determines whether or not a prize is established (step S67). When the main CPU 41 determines that a prize has been established, the main CPU 41 conducts a payout of coins according to the number of coin-ins and the prize (step S68).

When the main CPU 41 has conducted the processing of step S66 or the processing of step S68, or determined that any of the prizes has not been established in step S67 (in a case in which the main CPU 41 determines that the game is lost), the main CPU 41 reads the number T of bonus games stored in the RAM 43 and subtracts one from the value of the number T of bonus games. Then, the main CPU 41 stores again in the RAM 43 the number T of bonus games after subtraction.

Next, the main CPU 41 determines whether or not the number of executed bonus games has reached the number of games determined in step S60 (step S70). More specifically, the main CPU 41 determines whether or not the number T of bonus games has reached 0; when the number T of bonus games is not 0, i.e., when the number of executed bonus games has not reached the number of games determined in step S60, the main CPU returns the processing to step S61 and repeats the above-described processing. Meanwhile, when the number T of bonus games T is 0, i.e., when the number of executed bonus games has reached the number of games determined in step S60, the main CPU 41 terminates the present subroutine.

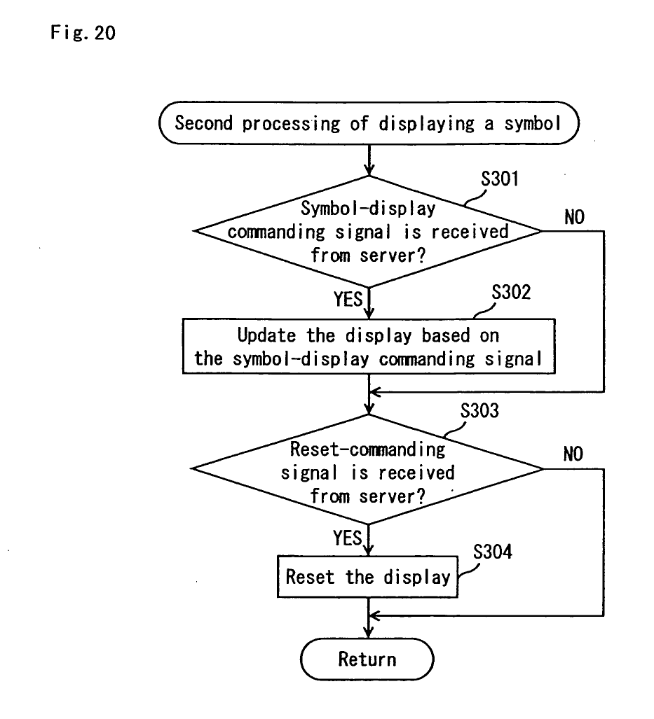

FIG. 20 is a flowchart illustrating a subroutine of second processing of displaying a symbol.

The second processing of displaying a symbol is invoked and executed by the main CPU 41 at a predetermined timing, apart from the game execution processing illustrated in FIG. 1.

First, the main CPU 41 determines in step S301 whether or not to have received the symbol-display commanding signal commanding to display the second rescue symbol 201 to the predetermined display block 90, from the server 400. When the main CPU 41 determines not to have received the symbol-display commanding signal, the main CPU 41 shifts the processing to step S303.

On the other hand, when the main CPU 41 determines to have received the symbol-display commanding signal, the main CPU 41 displays the second rescue symbol 201 to the predetermined display block 90 in the second display portion 92, based on the received symbol-display commanding signal, in step S302.

Next, in step S303, the main CPU 41 determines whether or not to have received the reset-commanding signal. Namely, the main CPU 41 determines whether or not to have received from the server 400 the reset-commanding signal commanding to reset the display of the second rescue symbol 201 in the predetermined display block 90, or the reset-commanding signal commanding to reset the display of the first rescue symbol 200 and the second rescue symbol 201 in the second display portion 92.

When the main CPU 41 determines not to have received the reset-commanding signal, the main CPU 41 terminates the preset subroutine.

On the other hand, when the main CPU 41 determines to have received the reset-commanding signal, the main CPU 41 resets in step S304 the display in the second display portion 92, based on the received reset-commanding signal.

More specifically, when the main CPU 41 determines to have received the reset-commanding signal commanding to reset the display of the second rescue symbol 201 in the predetermined display block 90, the main CPU 41 deletes the second rescue symbol 201 in this display block 90; when the main CPU 41 determines to have received the reset-commanding signal commanding to reset the display of the first rescue symbol 200 and the second rescue symbol 201 in the second display portion 92, the main CPU 41 deletes all the first rescue symbols 200 and the second rescue symbols 201 in the second display portion 92.

After conducting the processing of step S304, the main CPU 41 terminates the present subroutine.

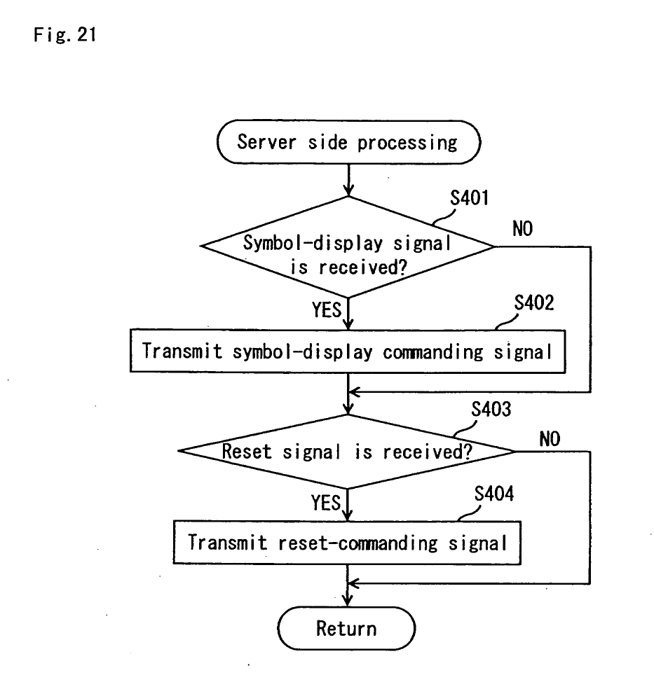

FIG. 21 is a flowchart illustrating a subroutine of server side processing executed in a server according to the present embodiment.

First, in step S401, the CPU 401 included in the server 400 determines whether or not to have received a symbol display signal indicating that the first rescue symbol 200 has been displayed in a display block 90, from any of the slot machines 10 configuring the gaming system 500.

When the main CPU 41 determines not to have received the symbol display signal, the CPU 401 shifts the processing to step S403.

On the other hand, the CPU 401 transmits in step S402 a symbol-display commanding signal commanding to display the second rescue symbol 201 to the corresponding display block 90, to the slot machines 10 other than the slot machine 10 from which the CPU 401 has received the symbol display signal in step S401.

Next, in step S403, the CPU 401 determines whether or not to have received a reset signal from any of the slot machines 10 configuring the gaming system 500. Namely, the CPU 401 determines whether or not to have received a reset signal indicating that the display of the first rescue symbol 200 in the second display portion 92 has been reset, or a reset signal indicating that the display of the second rescue symbol 201 in the second display portion 92 has been reset.

When the CPU 401 determines not to have received the reset signal, the CPU 401 terminates the present subroutine.

On the other hand, when the CPU 401 determines to have received the reset signal, the CPU 401 transmits in step S404 a reset-commanding signal to the slot machines 10 other than the slot machine 10 from which the CPU 401 has received the reset signal in step S403.

More specifically, when the CPU 401 determines to have received a reset signal indicating that the display of the first rescue symbol 200 in the second display portion 92 has been reset, the CPU 401 transmits a reset-commanding signal commanding to reset the display of the second rescue symbol 200 in the corresponding display block 90; when the CPU 401 determines to have received a reset signal indicating that the display of the second rescue symbol 201 in the second display portion 92 has been reset, the CPU 401 transmits a reset-commanding signal commanding to reset the display of the first rescue symbol 200 or the second rescue symbol 201 in the corresponding display block 90.

After conducting the processing of step S404, the CPU 401 terminates the present subroutine.

As described above, the gaming system 500 according to the present embodiment comprises the plurality of slot machines 10 capable of communicating with one another through the communication line 501, each of the slot machines 10 including the lower image display panel 16 (the display) to which an image can be displayed, the touch panel 69 (the selection input device) with which a selection operation of whether or not to receive an award can be input, and the mother board 40 (the controller). The mother board 40 is programmed to conduct the processing of (a) displaying, to the lower image display panel 16, the first display portion 91 having display blocks 28 arranged in a matrix with equal numbers of rows and columns, and the second display portion 92 having display blocks 28 arranged in a matrix with the same dimensions as the dimensions of the matrix in the first display portion 91, (b) rearranging a symbol to each of the display blocks 28 in the first display portion 91, (c) providing a normal award, based on the symbols rearranged to the first display portion 91 or a combination of the symbols, (d) additionally displaying, when the first rescue symbol 200 is rearranged to any of the display blocks 28 in the first display portion 91, this first rescue symbol 200 to the corresponding display block 90 in the second display portion 92, (e) additionally displaying the first rescue symbol 200, which has been rearranged to any of display blocks 28 in a first display portion 91 of another slot machine 10 capable of communicating through the communication line 501, to the corresponding display block 90 in the second display portion 92, as a second rescue symbol 201, (f) providing a special award, when a plurality of the first rescue symbols 200 are displayed to the second display portion 92 in a bingo state as a result of repeatedly conducting the processing (d) and the processing (e) and an input of receiving the award is entered through the touch panel 69, and (g) providing an award larger than the special award, when a plurality of the first rescue symbols 200 are displayed to the second display portion 92 in a bingo state after an input of not receiving the award has been entered, through the touch panel 69, for the bingo state of a plurality of the first rescue symbols 200 displayed in the second display portion 92, as a result of repeatedly conducting the processing (d) and the processing (e).

More specifically, in each of the slot machines 10 configuring the gaming system 500, there is provided the special award based on the arrangement of the first rescue symbols 200 displayed to the second display portion 92, separately from the normal award based on the symbols rearranged in the first display portion 91 or a combination thereof. Therefore, there is a possibility that even a player having difficulty in acquiring the normal award in games in the first display portion 91 wins the special award. Further, this special award is provided every time the first rescue symbols 200 are displayed to the second display portion 92 in the arrangement forming a bingo combination, regardless of the number of continuous losses in games in the first display portion 91. Accordingly, it is possible to continuously provide a return to the player who cannot receive the normal award and suffers increasing losses.

Also, as described above, to the second display portion 92, in addition to a first rescue symbol 200 rearranged in the first display portion 91 of the slot machine 10 being displayed, a first rescue symbol 200 rearranged in a first display portion 91 of another slot machine 10 is displayed as a second rescue symbol 201. Accordingly, there can be added a new game property of establishing a bingo combination of the first rescue symbols 200 under an environment where the first rescue symbols 200 and the second rescue symbols 201 are displayed, in order to receive a return.

As described above, a new game property can be added, concurrently with providing relief for the player who cannot acquire the normal award. Thus, it is possible to ease psychological burden on the player of continuously losing games in the first display portion 91.

Further, the player can receive the special award when the first rescue symbols 200 are arranged in a bingo state along a line, or the player can continue on games, without receiving the special award at this point, in order to receive a larger award until the first rescue symbols 200 are displayed in a bingo state along more lines. Therefore, the player can select the level of relief to receive, whereby it becomes possible to meet the needs of more players who desire for relief.

Further, according to the gaming system 500, the display of the first rescue symbol 200 in the second display portion 92 is reset when an award based on the symbols rearranged to the first display portion 91 or a combination thereof is a previously determined award (e.g., a payout of a predetermined amount of game media, and generation of a bonus game).

More specifically, a game for providing relief in the second display portion 92 is reset when a certain amount of profit has been provided to the player in games in the first display portion 91. Thus, it is possible to prevent a superfluous provision of a profit to the player who has received the profit in the games in the first display portion 91, and to more accurately provide a return to the player who has not acquired a profit.

According to the gaming system 500, a game is executed for providing relief in the second display portion 92 when a predetermined amount of BET (“RESCUE BET”) has been placed.

Accordingly, when the player desires for relief in a case of continuously losing games, it is possible to accurately provide a return to the player by making the player place a predetermined amount of BET.

Further, according to the gaming system 500, when a first rescue symbol 200 is rearranged to a first display portion 91 of a single slot machine 10, the second rescue symbol 201, i.e. the first rescue symbol 200 in the other slot machines 10 can be cleared; on the other hand, when a first rescue symbol 200 is rearranged to a first display portion 91 of another slot machine 10, the first rescue symbol 200 that has been already displayed in the above-mentioned single slot machine 10 is cleared. Therefore, in a game in the second display portion 92, since the player completes with players on the other slot machines 10, it becomes possible to increase pleasure of the player at the time of receiving a return, and to make the game for receiving a return more entertaining.

In the present embodiment, a case has been described in which the second display portion 92 is displayed on condition that a predetermined amount of BET (“RESCUE BET”) is placed. However, in the present invention, the second display portion 92 may be displayed without the predetermined amount of BET.

Moreover, in the present embodiment, a case has been described in which the display of the first rescue symbol 200 is reset when a predetermined amount of payout has been conducted or a bonus game has been generated in the first display portion 91. However, in the present invention, the condition for resetting a display of the first specific symbol in the second display portion is not limited thereto. For example, the display of the first specific symbol in the second display portion may be reset when a predetermined number of games are played.

Further, in the present embodiment, when a return has been provided in a single slot machine 10 out of the slot machines 10 configuring the gaming system 500, the displays of the second display portion 92 in all the slot machines 10 are reset, namely the game in the second display portion 92 is reset. However, in the present invention, when a return has been provided in a single gaming machine, the display in the second display portion may be reset only in the gaming machine at which the return has been provided.

Furthermore, although the case has been described in which the selection input device and the BET input device in the present embodiment are the touch panel 69, the selection input device and the BET input device may be, for example, a physical button (e.g., a push button switch) provided in the gaming machine, in the present invention.

Moreover, in the present embodiment, the specific arrangement in the present invention is an arrangement forming a bingo combination. However, the specific arrangement in the present invention is not limited thereto; for example, an arrangement may be adopted in which two or more first specific symbols are displayed adjacent to one another.

Also, in the present embodiment, a case has been described in which the slot machines 10 configuring the gaming system 500 are capable of communicating with one another through the server 400. However, in the present invention, gaming machines configuring a gaming system may be capable of directly communicating with one another without a server. In that case, a configuration can be adopted in which the gaming machines conduct transmission of signals directly with one another.

In the present embodiment, although the case has been described in which the gaming machine is a video slot machine, the gaming machine in the present invention may be a mechanical slot machine with reels.

Although the present invention has been described with reference to embodiments thereof, these embodiments merely illustrate specific examples, not restrict the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming system comprising:
a plurality of gaming machines capable of communicating with one another through a communication line, each of said gaming machines including a display to which an image can be displayed and a controller,
said controller programmed to conduct the processing of
(a) displaying, to said display, a first display portion having display blocks arranged in a matrix with equal numbers of rows and columns and
a second display portion having display blocks arranged in a matrix with the same dimensions as the dimensions of the matrix in said first display portion,
(b) rearranging a symbol to each of the display blocks in said first display portion,
(c) providing a normal award, based on the symbols rearranged to said first display portion or a combination of the symbols,
(d) additionally displaying, when a first specific symbol is rearranged to any of the display blocks in said first display portion, this first specific symbol to the corresponding display block in said second display portion,
(e) additionally displaying said first specific symbol, which has been rearranged to any of display blocks in a first display portion of another gaming machine capable of communicating through the communication line, to the corresponding display block in said second display portion, as a second specific symbol, and
(f) providing a special award, when a plurality of said first specific symbols are displayed to the second display portion in a specific arrangement as a result of repeatedly conducting said processing (d) and said processing (e).

2. The gaming system according to claim 1,
wherein
said controller is further programmed to conduct the processing of
(g) resetting the display of said first specific symbol in said second display portion, when an award previously determined based on the symbols rearranged to said first display portion or a combination of the symbols has been provided in said processing (c).

3. The gaming system according to claim 1, wherein
each of said gaming machines further comprises a BET input device with which a BET can be input; and
said processing (a) includes
displaying to said display, a first display portion having display blocks arranged in a matrix with equal numbers of rows and columns, and
displaying to said display, a second display portion having display blocks arranged in a matrix with the same dimensions as the dimensions of the matrix in said first display portion, when a predetermined amount of BET has been input through said BET input device.

4. The gaming system according to claim 1,
wherein
said controller is further programmed to conduct the processing of
(h) resetting, when said first specific symbol is rearranged to any of the display blocks in said first display portion and said second specific symbol has been displayed to the corresponding display block in said second display portion, the display of said second specific symbol in the corresponding display block in said second display portion; and
(i) resetting, when said first specific symbol has been displayed to any of the display blocks in said second display portion and said first specific symbol is rearranged to the corresponding display block in a first display portion of any of the other gaming machines capable of communicating through the communication line, the display of said first specific symbol in the corresponding display block in said second display portion.

5. The gaming system according to claim 1,
wherein
said processing (f) includes
providing a special award, when said first specific symbol has been displayed to all the display blocks in a single row, column, and/or diagonal of said second display portion as a result of repeatedly conducting said processing (d) and said processing (e).

6. A gaming system comprising:
a plurality of gaming machines capable of communicating with one another through a communication line, each of said gaming machines including a display to which an image can be displayed, a selection input device with which a selection operation of whether or not to receive an award can be input, and a controller,
said controller programmed to conduct the processing of
(a) displaying, to said display, a first display portion having display blocks arranged in a matrix with equal numbers of rows and columns and
a second display portion having display blocks arranged in a matrix with the same dimensions as the dimensions of the matrix in said first display portion,
(b) rearranging a symbol to each of the display blocks in said first display portion,
(c) providing a normal award, based on the symbols rearranged to said first display portion or a combination of the symbols,
(d) additionally displaying, when a first specific symbol is rearranged to any of the display blocks in said first display portion, this first specific symbol to the corresponding display block in said second display portion,
(e) additionally displaying said first specific symbol, which has been rearranged to any of display blocks in a first display portion of another gaming machine capable of communicating through the communication line, to the corresponding display block in said second display portion, as a second specific symbol,
(f) providing a special award, when a plurality of said first specific symbols are displayed to the second display portion in a first specific arrangement as a result of repeatedly conducting said processing (d) and said processing (e) and an input of receiving the award is entered through said selection input device, and
(g) providing an award larger than said special award, when a plurality of said first specific symbols are displayed to said second display portion in a second specific arrangement after an input of not receiving the award has been entered, through said selection input device, for the first specific arrangement of a plurality of said first specific symbols displayed in said second display portion as a result of repeatedly conducting said processing (d) and said processing (e).

7. The gaming system according to claim 6,
wherein
said controller is further programmed to conduct the processing of
(h) resetting the display of said first specific symbol in said second display portion, when an award previously determined based on the symbols rearranged to said first display portion or a combination of the symbols has been provided in said processing (c).

8. The gaming system according to claim 6,.
wherein
each of said gaming machines further comprises a BET input device with which a BET can be input; and
said processing (a) includes
displaying to said display, a first display portion having display blocks arranged in a matrix with equal numbers of rows and columns, and
displaying to said display, a second display portion having display blocks arranged in a matrix with the same dimensions as the dimensions of the matrix in said first display portion, when a predetermined amount of BET has been input through said BET input device.

9. The gaming system according to claim 6,
wherein
said controller is further programmed to conduct the processing of
(i) resetting, when said first specific symbol is rearranged to any of the display blocks in said first display portion and said second specific symbol has been displayed to the corresponding display block in said second display portion, the display of said second specific symbol in the corresponding display block in said second display portion; and
(j) resetting, when said first specific symbol has been displayed to any of the display blocks in said second display portion and said first specific symbol is rearranged to the corresponding display block in a first display portion of any of the other gaming machines capable of communicating through the communication line, the display of said first specific symbol in the corresponding display block in said second display portion.

10. The gaming system according to claim 6,
wherein
said processing (f) includes
providing a special award, when said first specific symbol has been displayed to all the display blocks in a single row, column, and/or diagonal of said second display portion as a result of repeatedly conducting said processing (d) and said processing (e) and an input of receiving the award has been entered through said selection input device; and
said processing (g) includes
providing an award larger than said special award, when said first specific symbol is displayed to all the display blocks in a single row, column, and/or diagonal of said second display portion after an input of not receiving the award has been entered, through said selection input device, for said first specific symbol being displayed in all the display blocks in another single row, column, and/or diagonal of said second display portion, as a result of repeatedly conducting said processing (d) and said processing (e).

11. A method for controlling a gaming machine used in a gaming system comprising a plurality of gaming machines capable of communicating with one another through a communication line, each of said gaming machines including a display to which an image can be displayed and a controller, the method comprising the steps of:
(a) displaying, to said display, a first display portion having display blocks arranged in a matrix with equal numbers of rows and columns and
a second display portion having display blocks arranged in a matrix with the same dimensions as the dimensions of the matrix in said first display portion;
(b) rearranging a symbol to each of the display blocks in said first display portion;
(c) providing a normal award, based on the symbols rearranged to said first display portion or a combination of the symbols;
(d) additionally displaying, when a first specific symbol is rearranged to any of the display blocks in said first display portion, this first specific symbol to the corresponding display block in said second display portion;
(e) additionally displaying said first specific symbol, which has been rearranged to any of display blocks in a first display portion of another gaming machine capable of communicating through the communication line, to the corresponding display block in said second display portion, as a second specific symbol; and
(f) providing a special award, when a plurality of said first specific symbols are displayed to the second display portion in a specific arrangement as a result of repeatedly conducting said step (d) and said step (e), each of said steps conducted by said controller.

12. The method for controlling a gaming machine according to claim 11, the method further comprising the step of
(g) resetting the display of said first specific symbol in said second display portion, when an award previously determined based on the symbols rearranged to said first display portion or a combination of the symbols has been provided in said step (c), the step conducted by said controller.

13. The method for controlling a gaming machine according to claim 11,
wherein
said step (a) includes
said controller displaying to said display, a first display portion having display blocks arranged in a matrix with equal numbers of rows and columns, and
displaying to said display, a second display portion having display blocks arranged in a matrix with the same dimensions as the dimensions of the matrix in said first display portion, when a predetermined amount of BET has been input through a BET input device with which a BET can be input.

14. The method for controlling a gaming machine according to claim 11, the method further comprising the steps of:
(h) resetting, when said first specific symbol is rearranged to any of the display blocks in said first display portion and said second specific symbol has been displayed to the corresponding display block in said second display portion, the display of said second specific symbol in the corresponding display block in said second display portion; and
(i) resetting, when said first specific symbol has been displayed to any of the display blocks in said second display portion and said first specific symbol is rearranged to the corresponding display block in a first display portion of any of the other gaming machines capable of communicating through the communication line, the display of said first specific symbol in the corresponding display block in said second display portion, each of said steps conducted by said controller.

15. The method for controlling a gaming machine according to claim 11,
wherein
said step (f) includes
said controller providing a special award, when said first specific symbol has been displayed to all the display blocks in a single row, column, and/or diagonal of said second display portion as a result of repeatedly conducting said step (d) and said step (e).
